(19) United States
(12) Patent Application Publication
(10) Pub. No.: US 2026/0205759 A1
(43) Pub. Date: Jul. 16, 2026

(54) INTERACTIVE MIXED REALITY AUDIO TECHNOLOGY

(71) Applicant: Moea Technologies, Inc., Spokane, WA (US)

(72) Inventors: John Rowland Correia, Spokane, WA (US); Candy Lynn Correia, Spokane, WA (US); Justis Damon Simmons, Seattle, WA (US); Anastasia Andreyevna Tajik, Spokane, WA (US); Zabi Khan, Spokane, WA (US)

(21) Appl. No.: 19/438,258

(22) Filed: Dec. 31, 2025

Related U.S. Application Data
(63) Continuation of application No. 18/257,543, filed on Dec. 14, 2021, now abandoned.
(60) Provisional application No. 63/125,312, filed on Dec. 14, 2020.

(51) Int. Cl. H04S 7/00; H04R 1/10

(52) U.S. Cl. CPC H04S 7/304; H04R 1/1041; H04R 2460/07; H04S 2400/11; H04S 2420/11

(57) ABSTRACT

Techniques for implementing an Interactive Mixed Reality Audio (IMRA) system are described herein. In some examples, the IMRA system can store a plurality of sounds, receive sensor input, detect occurrence of an event based on the input received, generate audio signals to create a created audio environment based on a sound of the plurality of sounds and the detected occurrence of the event; and produce an audio output from the generated audio signals, the audio output representing the created audio environment.

### PRIORITY

This application is a continuation of and claims priority to U.S. patent application Ser. No. 18/257,543, filed Jun. 14, 2023, which is the U.S. National Phase Application of PCT/US2021/063415, filed Dec. 14, 2021, which claims priority to U.S. Provisional Application No. 63/125,312, filed Dec. 14, 2020, which are incorporated herein by reference for all purposes.

### BACKGROUND

Traditional technologies underlying conventional mixed and augmented reality are fungible and seldom applied in a consistent manner. The following examples possess innate constraints in both their experiences and construction of said experiences:
HOLOLENS by MICROSOFT is a bulky head-mounted display providing augmented reality experiences, which include both visual and audio immersion. The HOLOLENS headset, much like other augmented reality headsets, places a virtual layer on top of the real world. This virtual layer includes both spatial audio and three-dimensional graphics.
POKÉMON GO is an augmented reality game that blends the virtual world of POKÉMON with the real world around a user. The game uses a global positioning system (GPS) on a user's mobile device to locate POKÉMON, or virtual creatures, which are rendered three-dimensionally on a user's phone screen and appear to be in front of them in real-life.
Black Box VR is a virtual reality (VR) gym based in Boise, ID. The gym provides gamified fitness experiences by placing users in a headset and haptic wrist bands. Audio merely accompanies visual effects in an effort to immerse users in a virtual world.
In the sports app, HOMECOURT, a user is required to have a mobile computing device, which leverages computer vision, to provide an interactive, but not immersive, off-screen or on-screen active sports experience. Some athletes use HOMECOURT to access interactive physical games via their phone or tablet in contrast to even more resource-intensive hardware in high tech gymnasiums.

Current adaptations of mixed reality focus heavily on rendering objects visually. Current adaptations of mixed reality fail to account for the innate limitations of visual perception, (e.g., viewing fidelity, the human visual perception radius), physical distractions including the feeling derived from bulky wearables, and the introduction of new visual stimulation such as content on the screen that can be distracting to the training or actions being performed.

Traditional virtual reality (VR), augmented reality (AR), and mixed reality (XR) focus on providing an enhanced experience to their users through a screen (i.e., monitor, mobile phone, MICROSOFT HOLOLENS) or lens (i.e., GOOGLE GLASS).

These conventional technologies focus on either generating a visually centric experience or the capture and analysis of physical actions. With these conventional technologies, the designed audio interfaces and environments either attempts to match the images on the screens (i.e., HOLOLENS, POKEMON GO, BLACK BOX VR, SNAPCHAT) or provide feedback on the captured and analyzed physical actions (i.e., HOMECOURT, NOAH BASKETBALL). Limitations to such approaches for training that includes physical action include:
The head mounted displays create a user experience that hinders the normal actions performed in a normal, non-technical environment (i.e., one would not play a basketball game with a bulky headset).
Non-head mounted displays can add visual distractions and/or visual content that can distract a user from performing action freely and/or in a more realistic training and/or performance environment (i.e., dribbling a basketball and looking at a screen is not realistic, as a user, in practice or in a game, does not look at a screen while dribbling a basketball). Further, training environments do not normally include large monitors to viewing so mobile devices are the only practical solution and usually have small displays.
In the case of HOMECOURT and NOAH BASKETBALL, the audio feedback is instructional and results based, which does not create a mixed reality experience that can enhance the training environment with realistic and fictional audio characteristics that improve the actual experience and future performances (i.e., says “shot made” and not a continual audio experience with artificial crowd cheering and/or fictional explosions).
Detailed feedback on actions is not real-time, usually provided by a trainer or reviewed on a screen after an action is, or actions are, performed.

Among other things, this disclosure addresses limitations in conventional solutions found in VR, AR, XR, audio games, and interactive physical games.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures are depicted not to scale with each other.

FIG. 1 illustrates an example mono/stereo configuration of an Interactive Mixed Reality Audio (IMRA) system.

FIG. 2 illustrates an example spatial audio configuration of an Interactive Mixed Reality Audio (IMRA) system.

FIG. 3 is a diagram of an example configuration of spatial objects overlaid on a basketball arena.

FIG. 4 is a diagram of an example user interface for configuration of spatial objects from an IMRA system.

FIG. 5 is a diagram of an example illustration of configuration of spatial objects from an IMRA system.

FIG. 6 is a flow chart with example operations associated with an IMRA system.

FIG. 7 illustrates an example environment with various components associated with an IMRA system.

FIG. 8 is a flow chart with example operations associated with an IMRA system.

FIG. 9 illustrates an example environment with various components associated with an IMRA system.

FIG. 10 is a flow chart with example operations associated with an IMRA system.

FIG. 11 illustrates an example multi-user, multi-location environment with various components associated with an IMRA system.

FIG. 12 illustrates an example of how environments associated with a multi-user, multi-location IMRA system can be superimposed.

FIG. 13 is a flow chart with example operations associated with an IMRA system.

FIG. 14 illustrates an example user interface that an IMRA system as described herein can present during a configuration process.

FIG. 15 illustrates examples of locations of spatial audio feedback provided by an IMRA system as described herein during golf, basketball, and soccer, respectively.

FIG. 16 illustrates an example configuration of an IMRA system as described herein.

FIG. 17 illustrates an example configuration of an IMRA system as described herein.

FIG. 18 illustrates an example configuration of an IMRA system as described herein.

FIG. 19 illustrates an example configuration of an IMRA system as described herein.

FIG. 20 illustrates an example configuration of an IMRA system as described herein.

FIG. 21 illustrates an example configuration of an IMRA system as described herein.

FIG. 22 illustrates an example configuration of an IMRA system as described herein.

FIG. 23 illustrates an example configuration of an IMRA system as described herein.

FIG. 24 is a block diagram illustrating example detail of a computing resource of an IMRA system as described herein.

### DESCRIPTION

The present disclosure describes technology that can be used in the fields of physical training and/or games. In some examples, the disclosure pertains to methods and systems for the creation and presentation of interactive mixed reality audio that can be standalone or incorporated into other methods and/or solutions that can track movements and/or outcomes-outcomes meaning measurable or observed results of physical actions, a result of a physical action. The disclosure describes technology that can generate and provide an audio experience to enhance a physical training and/or gaming environment. As computers have been designed to become more intelligent and to include programming to be able to track users and understand user behaviors, technologies are being developed to capture, analyze, and report on physical activities, which have led to some insights from athletic data analysis programs like SECOND SPECTRUM, PLAYSIGHT, STATS PERFORM. Applications of similar technologies use traditional mobile devices (e.g., smart phones, tablet computers) to create interactive games that can provide real-time capturing and reporting outcomes associated with these games. An example of an alternative application using capture and analysis of physical activity is HOMECOURT, a mobile consumer product, which leverages the aforementioned technologies to provide interactive physical games to train athletes. NEX TEAM, the creator of HOMECOURT, utilizes artificial intelligence (AI) to provide real-time interactive games based on user actions and outcomes. The underlying capabilities of HOMECOURT involve real-time user tracking, remote multiplayer gaming, and touchless control, on smart phones and tablet computers.

The innovation described herein is Interactive Mixed Reality Audio (IMRA). IMRA can merge technologies from two or more of traditional video games, modern AR/VR/XR experiences, interactive physical technologies, and/or conditioned behavior psychology (psychology embedded in video game and social media platform design) to generate a user experience. The generated user experience can produce an interactive audio environment that can allow a user to train, perform and/or play-without visual and/or physical impediments-in an audio experience, e.g., an immersive, gamified audio experience, that can provide strategically designed audio stimulation and/or feedback.

IMRA as described herein can utilize computing and/or audio devices to create an audio experience for users that can dynamically change based on identified behaviours and/or outcomes. The system described herein can be used by a wide range of individuals including any of athletes, physicians, police officers, fire fighters, mechanics, and more. The system can create a mixed reality experience including a system generated audio environment with which a user can physically interact. In examples, the system can monitor a physician practicing an operation and can provide sounds associated with the actions of the physician. In examples, a user can practice, e.g., basketball, soccer, etc. in front of an audibly rendered version of their favourite professional player generated by the IMRA system, which can provide encouragement and/or customized feedback, which the system can tailor to the user. This audio-based technology can augment the experience of an individual, or multiple individuals, performing actions necessitating reinforcement learning and/or those seeking deeper immersion and/or interactivity in a physical setting.

In examples, IMRA can be used to create audio games where users perform actions, which can have associated outcomes, which the system can capture and use as input into an experience engine, e.g., a game engine, to generate a gamified audio experience, which can be output using one or more of various methods, including using a single speaker and/or to spatial arrays. Such a gamified audio experience can be realistic and/or fictional.

In examples, IMRA can be used in a training setting to provide real-time spatial audio feedback based on actions and/or outcomes in a physical environment.

Conventional mixed reality is the merging of real-world and virtual worlds to produce new environments, where physical and digital objects co-exist and interact in real time. Conventional mixed reality technologies focus on producing visualizations (with or without associated audio) that merge virtual visual objects with physical objects into an interactive, real-time experience presented on a screen (e.g., MICROSOFT HOLOLENS) or through a lens (e.g., GOOGLE GLASS). In contrast to conventional mixed reality systems, the technology described herein can work independently or in conjunction with these visual experiences, uniquely focusing on producing an audio environment that merges virtual sounds with physical activities into an immersive, interactive, real-time experience presented by one or more audio output devices (e.g., loudspeakers, Bluetooth speakers, wearables such as glasses, headphones, earbuds, etc.). The innovative technology described herein are not limited by the type of speaker technology providing output.

A video game allows a user to use controls to interact with visual objects and environments displayed on a video screen (e.g., FORTNITE, MADDEN, GRAND THEFT AUTO). An audio game, however, is typically a screen-less game that users interact within an audio environment presented via audible devices (e.g., speakers, headphones, etc.). Traditionally audio games have been developed for the visually impaired (e.g., UNDEAD ASSAULT, CRAZY PARTY) and interaction with traditional audio games has been via a video game or computer controller. In contrast to conventional audio game systems, the technology described herein can be used to develop a physically interactive audio environment and/or game to be useful and enjoyable for all users. The IMRA system can capture inputs from movements and/or receive manual inputs to produce a virtual audio environment that the user can interact with and experience without relying on a computing device screen.

Traditional video games create a virtual environment through a screen that users can interact with via a controller or controllers. More recently, interactive physical games have been created using dedicated spaces, equipped with sensors and other hardware to monitor player actions within a game setting. Modern advances in technology, such as computer vision, mobile computing devices, and sensor tracking now allow users to play interactive physical games using mobile devices for the purposes of training or leisurely gaming. HomeCourt (e.g., U.S. Pat. No. 10,643,492) and sensor tracking allow for a largely screen-less training environment. Current applications of interactive physical games blend visual and audible instruction, interaction, and feedback. Although these conventional products allow users to play games actively, reliance on screens both tethers a user to their device and limits the potential applications of these conventional solutions.

In examples, the technology of this disclosure allows for the utilization of conventional interactive physical games as inputs into an IMRA system as described herein. Such inputs can provide information such as user location, pose, and/or outcomes which the system can then use to manipulate an included audio experience engine to create a dynamic virtual audio environment for individuals to train in and/or with.

Conventional movement analysis and sports science is centered around action capturing using various methods including computer vision and sensors. Conventionally these may be combined with data analytics to present results of analysis to users using various visualization methods (e.g., charts, tables, graphs, maps, infographics, dashboards). Conventional visualizations provide post movement and outcome analysis that is later reviewed by the user and training staff.

Gamification includes using game design to improve user engagement, productivity, performance, flow, learning, knowledge retention, ease of use, physical exercise, etc. Research on game elements in non-game contexts has shown that gamification can provide a positive influence on individuals'behavior. In examples, this disclosure describes gamified audio feedback that can be used to provide more immersive and immediate feedback, which can be more easily processed by trainers and/or users. Some conventional solutions may provide audio feedback limited to instructions or general crowd reactions. In contrast, an IMRA system as described herein differentiates because it can provide immersive, gamified audio feedback with realistic and/or fictional audio sources and/or sounds. In examples, in addition to, or instead of, providing feedback on the actual arc of a basketball shot (e.g., “33 degrees”), an IMRA system as described herein can associate this arc with fictional sounds and/or feedback from a celebrity basketball player, a coach, a crowd, etc. providing an immersive audio experience that can include spatial audio.

As mentioned, conventional standard audio feedback technologies provide audio feedback based on outcomes of actions. As one example, a user can get audio feedback on whether a shot was made, how many shots have been made in a session, and/or the location of where a shot goes in the hoop from a training or playing environment. In these cases, a computer determines whether an action was performed, and/or an outcome occurred, and then subsequently provides that feedback to the user via a speaker and/or headphones.

This disclosure describes IMRA technology that can combine detected actions, natural changes in the audio environment, such as event-signifying words or phrases, and/or outcomes with audio feedback, which can be spatialized. In examples, when an IMRA system detects a movement at a particular part of a person's body, the IMRA system can present audio feedback to the user that seems to originate from that part of the user's body (e.g., a buzz at feet in wrong position when shooting a basketball, heartbeat rate sound coming from heart area, etc.). In examples, an IMRA system can replicate a scene with situational factors that are not dictated based on actions or outcomes in the physical space but from the design of the audio environment such as the increase in crowd intensity as time gets closer to the end of the game. In examples, an IMRA system can associate audio to objects in the physical space, e.g., a golf club, a ball, etc. and/or can present audio feedback based on the positions and/or states of associated objects (e.g., club head open at top of swing can generate spatial feedback apparently from that position, etc.). In examples, the changes in the audio environment can occur due to a combination of actions and/or outcomes (e.g., the arc of a basketball shot and the location of the shot going through the hoop, the speed and spin rate of the baseball after being hit with a baseball bat, etc.).

Psychology on conditioned behavior (e.g., classical conditioning, operant conditioning, etc.) has been integrated into many contexts including video games and social media technology. These strategies develop conditioned associations between various triggers, behaviors, and rewards. The more a user experiences the associations between the triggers, behaviors, and rewards, the more the behaviors become sub-conscious and automatic.

IMRA technology as described herein can apply tenets of conditioned behavior and/or gamification theory in an immersive audio environment to encourage users to develop conditioned associations between audio-based triggers, physical behaviors, and audio-based rewards. An IMRA system can provide feedback according to such conditioned associations, which can increase audio game use and/or create an improved physical training environment. In examples, an IMRA system as described herein can be configured such that purpose (e.g., fun, improved skill development, etc.), frequency (how often a user will interact with the IMRA) and/or duration (how long a user will interact with the IMRA during a session) can be used to develop, select, and/or configure an appropriate immersive audio environment. Based on these examples and others, the IMRA system can automatically select a list of audio environments and/or audio elements to present to a user to choose from for an interactive session.

IMRA audio technology can help improve understanding of users'experiences and how user experiences can impact future behavior by providing audio environments (and associated specific sounds and objects later presented) that can help improve psychological and/or physiological outcomes. For example, training a user to improve their physical behavior with realistic crowd audio (e.g., football player with realistic crowd) can be shown to improve the user's game performance. Other audio sounds and/or environments that produce a similar or same type of internal affect in users can be used as a conditioning environment to improve a user's performance. The greater number of sounds and more diverse audio environments are able to be created for practical outcomes, the more users can benefit from using an IMRA system.

Additional examples and more detail about the IMRA technology including various types of audio environments, audio devices, types of audio design, technical overview of the design and various example use cases for the IMRA technology and system are provided throughout this disclosure.

An audio environment can be artificially created by software developers and sound designers that either design an environment that is realistic (e.g., playing in front of a crowd), fictional (e.g., playing with fictional created creatures or in fictional created environments) or a combination of the two (e.g., realistic crowd with gamified sound effects). In an example, an IMRA system can detect a user performing specified physical actions that are related to either general physical training (e.g., jumping jacks, push ups, planks, lifting weights, etc.) or specific physical training (e.g., golf swing, kicking goals, shooting baskets, etc.) that can create interactive changes in an audio environment. For example, when a user makes a basketball shot, an IMRA system can produce a sound of a crowd cheering, and/or the sound of an explosion, and/or one or more other sounds. The audio environment, and changes in the environment, can be artificially created within the IMRA system and can be from real and/or fictional sources.

In examples, an IMRA system in an audio environment can create artificial stimuli for the training and/or game environment that can be used as fictional audio triggers that can instruct a user to conduct a certain action. And/or, in examples, an IMRA system in an audio environment can create realistic audio triggers that can increase the difficulty to conduct a certain action. In examples, an IMRA system can present a change in an audio environment as an audio “reward” or audio feedback to the user, which can promote or discourage future actions and/or outcomes. In some instances, an IMRA system can provide specific sounds, such as:
audio brands (e.g., trademarked sounds, copyrighted songs/jingles, characters, voices, sayings, environments, etc.), voices and/or sounds of specific people (e.g., famous people, famous announcers, friends, family, characters, etc.),
existing recognizable sounds (e.g., fans, famous sayings, explosions, chimes, cash register sounds, jackpot sounds, animal sounds, etc.),
unrecognizable sounds (e.g., fictional sounds, newly developed sounds, etc.),
sounds from a microphone associated with the system (e.g., another person present at the location or remotely connected, trainers, fans, other players, etc.),
Non-player characters (NPC),
algorithmically modified sounds (e.g., sound modified with Natural Language Processing audio algorithms, voice cloning, etc.), and/or
any combination thereof,
   as audio stimulation to enhance a physical training and/or physical gaming environment. Various methods can be used to develop these audio sounds including naturally recorded sounds, modification of existing recorded sounds, produced sounds, and Natural Language Processing audio algorithms that take an existing audio source (audible or text based) and reproduce a specific audio sound (e.g., any of the example sounds in this paragraph) used in the audio environment.

Any one or more of the audio sounds can be used to develop an audio environment in which a user can perform, including as (e.g., as a cartoon character, as a fictional character, as another or famous character or person, etc.) and/or with (e.g., with a cartoon character, as a fictional character, as another or famous character or person, etc.) the specific sound. In some examples, an IMRA system can produce an audio environment such as an immersive audio environment in which:
A user can perform (e.g., play a sport, perform a routine, perform an art, perform a task, etc.) in front of a crowd, fans, one or more celebrities, and/or in a simulated training environment.
A user can interact with an audio environment with audio rewards and/or feedback in the form of copyrighted songs, sayings, and/or sounds and/or trademarked sounds (e.g., ESPN sound, NBC chimes, etc.), or samples thereof.
A user can interact with an audio environment that can provide video game-like experiences. For example, an IMRA system can play a particular video game background music (e.g., Mario Brothers, Donkey Kong, Legend of Zelda, etc.) and/or various video game sounds (e.g., PowerUp, etc.) to provide audio feedback associated with particular outcomes.
A user can interact with remote viewers so that sound captured by a microphone associated with one or more remote viewers and/or a location of the one or more remote viewers is presented to the user in the user's physical environment.
A user can select a sound character (e.g., famous person, animal, fictional character, etc.), and as the user performs in their physical environment, the user can hear a customized audio environment that is tailored according to their sound character (e.g., user selects to play as Lebron James and hears an announcer calling Lebron James name after a made shot).
A user can select to play with, for, or against a specific team and/or character, and as the user performs in their physical environment, the user can hear a context-specific audio environment that is tailored according to the context specific sounds of the specific character (e.g., playing a putting game with Tiger Woods, playing for the L.A. Lakers, playing against the Toronto Maple Leafs, etc.).
A user can select to train in various levels of intensity for the environment such a first responder can select a very intense scene where babies are crying, gun shots go off more frequently, and/or urgent directions are given via their radio.
Using device detection (e.g., computer vision, sensor detection, existing game with detection methods, etc.) an IMRA system can connect audio sounds to specific devices with speakers in an interactive physical environment to mimic audio sounds in a training and/or game environment. For example, a speaker can be configured to the system and placed on a mannequin or a mannequin with a screen that changes based on the configured object. The IMRA system can provide specific interactive sounds via the speaker while a user performs various actions in a physical space (e.g., a mannequin and attached speaker can be placed on a soccer field, in a dance studio, on a stage, etc. and interactively produce audio that mimics a persons'voice and/or words).
The audio environment can change without inputs from the physical environment. In examples, if the user is not actively moving, the crowd intensity can die down and get bored over time or can get more anxious and impatient. In examples of a basketball player playing a shooting game against the IMRA system, a user can select the level of competition they want to play in and the system can increase the opponent's score accordingly. In examples, changes in the environment can be scripted where a firefighter enters a building that is burning, and the firefighter has a specified amount of time to save a person in the building and/or extinguish the fire before the fire gets too dangerous to be in.
   Audio objects can be tied to outcomes in the environment so that when outcomes occur at the location, the audio is presented from that location in space (e.g., sound from a moving object in the environment and/or position of body part(s) in the environment, etc.). In examples, audio objects can be tied to physical objects in a simulated environment like in a first responder training center whereas a user acts in the simulator, sounds like code alarms can come from specific locations in the simulated space and/or calls for help come from a specific room in the building.

An IMRA system can produce context relevant audio environments related to a user's desired performance environment (e.g., playing in front of a large crowd) and/or playing in front and/or with a famous player and/or playing through a sports season, etc. Even though some of these environments may not be realistic in the sense of actually occurring, the system can produce such audio features and/or environmental factors so that the user's imagination can come to life in the present with a mixed reality audio environment.

An IMRA system can produce an audio environment that is independent of context and/or actions and/or performance occurring in the physical space. The IMRA system can generate a non-context-relevant audio environment that can include designed objects and/or attributes that create virtual audio worlds that the user can interact with and/or in. In some examples, these non-context-relevant environments can be related to an existing environment from another context (e.g., shooting a basketball in an audio environment set to mimic a popular video game (e.g., Call of Duty, Fortnite, etc.) or putting a golf ball in front of the Kansas City Chief's football crowd. In some examples, the non-context-relevant environment can include a newly developed, fictional environment that provides a unique audio environment in which users can perform and/or interact. The creation of fictional audio environments provides immense variability for users to perceive events around them. Furthermore, the user in some cases can influence a sequence of events in a fictional audio environment through their actions, in which case elaborate narratives can be built around user interaction (e.g., a dynamic audio game).

In some examples, an audio environment can include various audio features from context-relevant and fictional audio environments. For example, a user can make a basketball shot and an IMRA system can provide cheers from the crowd and fictional sounds like a cash register, explosion, etc.

An IMRA system can be developed to have specific audio environments and objects customized based on various factors including demographics of the user (e.g., age, current country, favorite team), individual attributes (e.g., level of skill), prior performance in the system (e.g., previous use, progression in game, achievements, purchases), timing between actions/outcomes detected (e.g., shorter audio rewards for more frequent outcomes like kicking a soccer ball against a wall, longer audio rewards for less frequent outcomes like kicking a ball into a goal and then retrieving it).

An IMRA system can produce audio environments tailored to an associated selected output device. In some examples, an IMRA system can identify availability of a single loudspeaker and/or a multi-channel output setup. An IMRA system can detect that there is a connected speaker or multiple associated speakers, as personal speakers/headphones/earbuds, localized speakers, such as those of a phone and/or tablet computer, and/or loudspeaker(s). Based on the detected speaker(s), the IMRA system can produce a mono audio (single channel) audio experience to output over a single speaker and/or a multiple channel audio experience to output in a multi-channel output setup. In some examples, an IMRA system can produce an audio experience based on different spatial audio techniques and/or technologies.

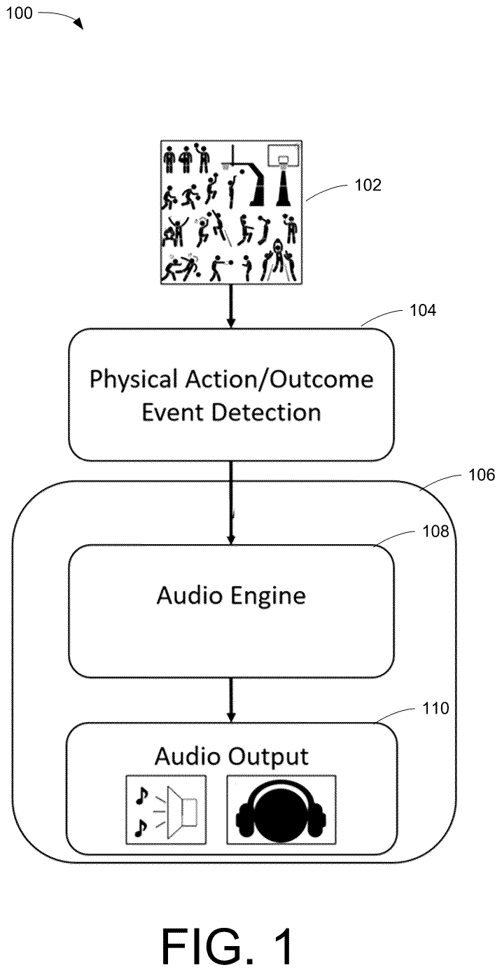

FIG. 1 illustrates an example mono/stereo configuration 100. Element 102 represents a numerous variety of example scenarios in which an IMRA system can be used. A sensor or detection component 104 is associated with the IMRA system and configured to detect a physical action and/or outcome. IMRA system 106, can include an audio engine 108 and produced audio output 110. In various examples, audio engine 108 represents an IMRA audio engine, which can include an independent agent and/or can be implemented with a Unity, Unreal, and/or bespoke engine. In some examples (not illustrated), an IMRA system can employ a separate audio engine and/or provide output to separate audio output devices.

Spatial audio provides an example of how IMRA technology as described herein can be leveraged with modern audio technology. Spatial audio has proven to be effective across a variety of mixed reality applications due in large part to the underlying science. Often referred to as binaural or 360-degree audio, spatial audio empowers users with three to six degrees of freedom. Degrees of freedom occur when a user is able to move their head on all axes (3Dof), as well as physically through space (6DoF). Mixed reality users can localize sounds from their virtual environment with these degrees of freedom using IMRA technology as described herein. With recent improvements in low latency, faster data transfer, and head tracking, auditory displays can now update the spatial sound field fast enough to compensate for listener head movements. However, each person hears differently due to head and ear shape, so spatial audio technologies, such as head related transfer function (HRTF), are also used to adjust for these minute differences. Together, these concepts, enabled by innovative IMRA technology, can be used to create an immersive experience entirely from spatial audio.

Components of spatial audio can be applied to achieve screenless immersion. Omitting conventional head-mounted display and/or reliance on a mobile computing device (smartphone/tablet) for visual stimulation, minimally invasive hardware can create the full breadth of an augmented audio experience. In examples, using manual inputs and/or sensors and spatial mapping via computer vision, player location and movement can inform a system of real-time changes in a user's audio-sensory experience, further contributing to audio immersion. Headphones (wired or wireless), which have noise canceling capabilities that reduce the outside noise, can increase immersion. With increased immersion, IMRA technology can provide audio cues or triggers to provoke desired behaviors and/or outcomes, which can lead to specific audio rewards. This cycle can condition users toward successful training or gaming outcomes.

Screenless immersion provided by IMRA technology and powered by accurate, real-time tracking (next-generation mobile computing devices, computer vision, sensors, precise GPS/Bluetooth) can revolutionize interactive physical gaming. These technologies can provide sensory immersion, while users navigate the physical world, from light mixed reality to full visual and audible augmentation.

Traditionally, innovation in spatial audio has been disfavored due to expensive equipment requirements for specialized recordings and the requirement of high-fidelity headphones for complete immersion. However, an IMRA system as described herein leverages a confluence of technology innovations, which now enables variations of spatial experiences that can mimic the sensory experience. These innovations include computer vision, haptic feedback systems, edge computing, machine learning, robotics, IoT, 5G, and wearable devices. At the intersection of these technologies IMRA technology can redefine the way humans learn, train, interact and live. IMRA technology as described herein can operate at this intersection. The current state of spatial computing and IMRA technology can also empower creators to design wholly novel experiences, tailor made for consumers.

Spatial audio allows for audio to seem as if it is coming from a position or positions in a sound environment. In relation to the technology described in this disclosure, spatial audio can be used to localize of sounds in an audio environment (also known as the sound space in spatial audio). This ability to localize sound can create an opportunity to add multiple audio dimensions to an audio environment which can enhance the experience in audio environments in various examples.

An IMRA system as described herein can produce various levels of spatial audio. For example, if head movement and location tracking is not traceable, the IMRA technology can create a standard spatial environment. If head movement is dynamically captured, but a user's location is not tracked by a camera, manual input and/or sensor associated with the IMRA system, a 3 degrees of freedom (3dof) user experience can be created. If, however, head movement and location of the user are tracked by a camera, manual input and/or sensor associated with the system, a 6 degrees of freedom (6dof) user experience can be created. An IMRA system can use various methods to capture, author and/or reproduce spatial audio experiences.

With spatial audio, an IMRA system can use technologies such as ambisonic microphones to capture ambisonic audio characteristics of a particular environment of interest. For example, an ambisonic microphone can be set in the middle of an arena to capture the spatial audio attributes of that location in the arena. In some examples, an IMRA system can use off-the-shelf tools such as FACEBOOK 360 SPATIAL WORKSTATION and DEAR REALITY to mix and produce sounds and positions into the audio environment.; in some examples, bespoke tools can be included as a component of or associated with an IMRA system. In some examples, one or more, or each sound of a plurality of sounds can carry metadata that can describe its position and rotation in the audio environment. In examples, sounds can be recorded for specific objects and/or the sounds can be mixed to create audio sounds specific to certain objects in the audio environment.

In examples, in 3dof, when an IMRA system receives input of dynamically captured head movement is (e.g., from computer vision, wearable sensors, internally with wearable audio devices, etc.), IMRA technology can account for head movement inside of the audio space to either naturally or electronically, keep audio localized in physical space. In at least one such example, if a user moves their head while using the technology, sound objects can hold their appropriate location in the audio environment.

In examples, in 6dof, an IMRA system can include location tracking so that when a user moves in their physical space, audio objects hold their appropriate location in the audio environment.

Whether using 3dof or 6dof, in some examples, an IMRA system can use off-the-shelf game engines such as Unity, Unreal, and/or bespoke experience engines, to create a multi-dimensional space in which a user can operate. In some examples, an IMRA system can use off-the-shelf audio middleware, such as Wwise or FMOD, and/or bespoke audio middleware, to design audio experience for use in a multi-dimensional experience engine. Further, in some examples, an IMRA system can use spatial audio technologies such a head-related transfer function (HRTF) or another function to transfer the developed audio environment to a user. In some examples, an IMRA system can use tools as RESONANCE AUDIO, STEAM AUDIO and/or SOUNDFIELD AUDIO and/or bespoke tools to convert the developed audio experience to a binaural signal that can be sent to an audio output device.

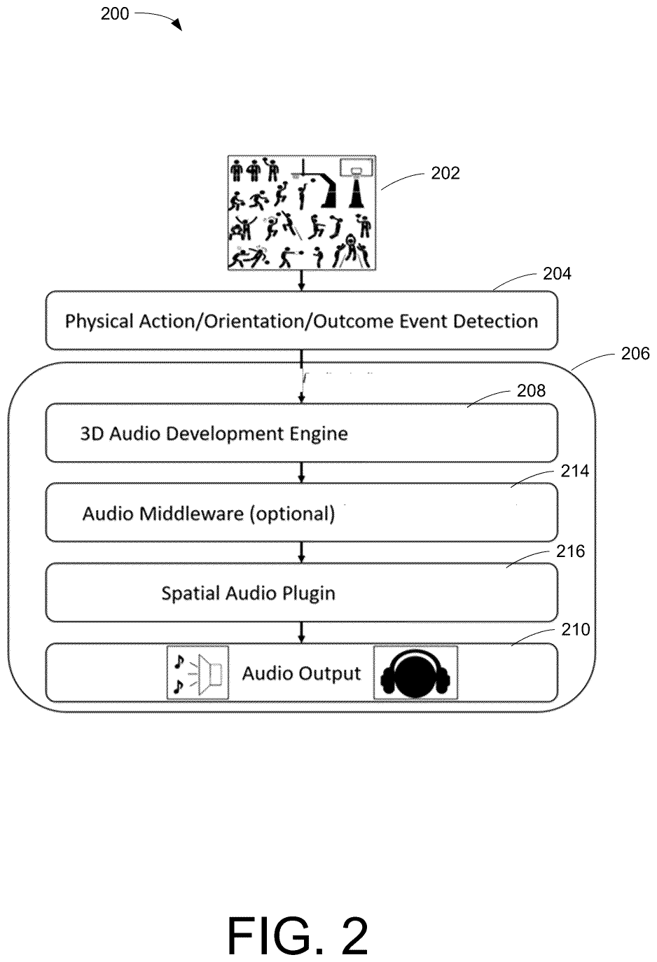

FIG. 2 illustrates an example spatial audio configuration 200. Element 202 (which can correspond to element 102, FIG. 1 in some examples) represents a numerous variety of example scenarios in which an IMRA system can be used. Sensor or detection component 204, which is associated with the IMRA system can be configured to detect a physical action, orientation of a user (location and/or rotation), and/or outcome. IMRA system 206 (which can correspond to element 106, FIG. 1 in some examples), can include a variety of components. Components of IMRA system 206 can include an audio development engine 208 and produced audio output 210 (which can correspond respectively to elements 108 and 110, FIG. 1 in some examples). In various examples, audio engine 208 represents an IMRA audio engine, which can include an independent agent and/or can be implemented with a Unity, Unreal, and/or bespoke experience engine. In some examples (not illustrated), an IMRA system can employ a separate audio engine and/or provide output to separate audio output devices. Components of IMRA system 206 can optionally use or include audio middleware 214, such as off-the-shelf audio middleware, Wwise or FMOD, and/or bespoke audio middleware, to design audio experience for use in a multi-dimensional experience engine. Components of IMRA system 206 can optionally use or include spatial audio technologies 216, such a head-related transfer function (HRTF) or another function. IMRA system 206 can use spatial audio technologies 216 to transfer the developed audio environment to a user. In some examples, IMRA system 206 can use tools as RESONANCE AUDIO, STEAM AUDIO and/or SOUNDFIELD AUDIO and/or bespoke tools to convert the developed audio experience to a binaural signal that can be sent to an audio output device.

The ability to create an audio environment (e.g., sound space) that can localize sounds can greatly enhance the mixed reality audio environment and add unique dimensions to the audio environment. In the audio environment, an IMRA system can provide specific sounds, such as
audio brands (e.g., trademarked and/or copyrighted songs and/or sounds, jingles, characters, voices, songs, sayings, etc.),
voices and/or sounds of specific people (e.g., famous people, famous announcers, friends, family, etc.),
existing recognizable sounds (e.g., fans, famous sayings, explosions, chimes, cash register sounds, jackpot sounds, animals, etc.),
realistic environment sounds (e.g., emergency scene, house burning, sports event, etc.),
unrecognizable sounds (e.g., fictional sounds, newly developed sounds, etc.),
enhanced sounds (e.g., using cinematic trope, etc.),
algorithmically modified sounds (e.g., sound modified with Natural Language Processing audio algorithms, voice cloning, etc.),
sounds from a microphone tied to the system (e.g., another person present at the location and/or remotely connected, such as trainers, fans, other players, etc.)
Non-player characters (NPC), and/or
a combination thereof,
   as objects into the audio environment. In some examples, an IMRA system can configure specific sounds to have an associated location and/or presence in the audio environment. As a user moves with their various degrees of freedom (yaw, pitch, roll, left/right, front/back, and/or up/down), an IMRA system can configure spatial audio objects to hold their perceived position relative to the user and/or user's environment . In examples, when using an IMRA system, if a sports player, e.g., a soccer player, basketball player, etc. gets closer to the sideline, the fans'sound developed for their audio environment can become louder, closer while holding their position in the physical space. These audio objects can serve as inanimate fixed objects with audio characteristics or animated objects that react to user actions. An example of the former can include the audio of a fire set ablaze when a user performs a certain action, and an example of the latter can include a defender in a ball game that reacts to a sports player's moves.

Any or all of the spatial audio objects can be incorporated into an audio environment to allow users to perform in the presence of, as, and/or with these audio objects. In various examples:
An IMRA system as described herein, can enable a user to perform in the presence of an audio object, which can provide audio interaction as the user performs certain actions with associated outcomes.
An IMRA system as described herein, can be configured to enable a user to perform as a particular object and/or player (e.g., as Lionel Messi, etc.). In such examples, the user's actions can produce changes in the IMRA audio environment that mimic the changes in audio environment as if the particular object and/or player were performing those actions (e.g., in response to detecting that the user makes a soccer goal, the IMRA system can produce the audio “GOOOAAAAL ... Lionel Messi,” and/or other appropriate feedback).
An IMRA system as described herein, can be configured to enable a user to play and/or train with such audio objects. Audio objects can be placed in the audio environment and can interact with the user/player. The interactions can be configured to align as if the audio object is on the same team with the user or is in the playing space (audio environment) as an opponent. In examples, the IMRA system can be configured for particular player(s) to provide feedback, e.g., trash talking as an opponent, or encouragement as a team member, in the playing space (audio environment) of the user. In some examples, the feedback (encouragement and/or trash talking, etc.) can be from one or more known people and/or fictional characters, e.g., Kevin Garnett, Zlatan Ibrahimović, etc. and/or Mickey Mouse, Darth Vader, etc.
An IMRA system as described herein, can configure a live audio source (captured by a local or remote microphone tied to the system) to connect to a specific object in the physical environment associated with a user or a virtual space associated with the user. The IMRA system can be configured to then broadcast the sounds captured by the microphone as if they were coming from that object and/or specified space.
An IMRA system as described herein, can provide an additional audio component for application to single and/or multiplayer games. IMRA can be used, for example, between two players in geographically separate spaces. Players can choose one or more of a variety of real people (e.g., Lebron James, Arnold Schwarzenegger, etc.) or fictional characters (e.g., Darth Vader, Bugs Bunny, etc.) to embody in the audio. In some examples, microphones on wireless earbuds can pick up player audio input and the IMRA system can process the input for changed output and/or for pure output to other player(s) audio environment. In other words, using an IMRA system as described herein, a user can configure one or more live audio sources (in the physical environment, remotely connected, or mixed) to translate the audio from the audio source to a desired audio object (e.g., convert a friend's voice to sound like another person's and/or character's voice, e.g., a known person like Shaquille O'Neal, a fictional character like Snow White, etc.). In some instances, IMRA can be used to have specific characters or brands communicate pre-determined scripts or sounds in the audio environment.
An IMRA system as described herein, can capture the sound of a user speaking into their own microphone, can manipulate the sound of the user's voice, and can produce manipulated audio based on the sound of the user's voice to enable the user to hear themselves as another person and/or character of their choice (e.g., Morgan Freeman, Lebron James, tweety bird, etc.). In this example, the audio object can be centered on the user, so the user experiences the output as though it is coming from their mouth.

In some examples, audio objects can be associated with physical objects in the physical space and configured to produce previously designed audio.
In examples, using an IMRA system as described herein, a user can be wearing earbuds with spatial audio capabilities, and as the user moves towards an object, e.g., a mannequin, a cone, another user, etc., the user can receive an interactive audio experience as if the object is producing sounds (e.g., famous basketball player talking to them, a bear growling, etc.).
In examples, using an IMRA system as described herein, a police officer can experience an audio environment similar to a call to a dangerous scene where fake guns can be configured so that when their trigger is pressed, spatially positioned sounds of a gunshot can be heard by the user. In some examples, the gun shot sounds can be combined with Haptic gloves, suits and/or other pieces that can provide the sensation of shooting a gun.
In examples, an IMRA system can be configured to associate an audio object with a physical object, body part, or physiological state so that the physical object, body part, or physiological state can produce spatially specific audio in the audio environment. For example, a ball or golf club can have an audio presence in the audio environment. For example, a player's arm position and/or heart rate can have their own dynamic audio presence in the audio environment.
In examples, an IMRA system can be configured such that physical objects are optional, and a user can customize specific virtual audio objects in their audio environment. For example, a basketball player/user can position the band, home bench, visiting bench, home fans, opposing fans, teammates, and/or opposing players in particular locations in the basketball player/user's physical environment so that when the basketball player/user trains and/or plays, these audio objects can produce audio from the specified positions.

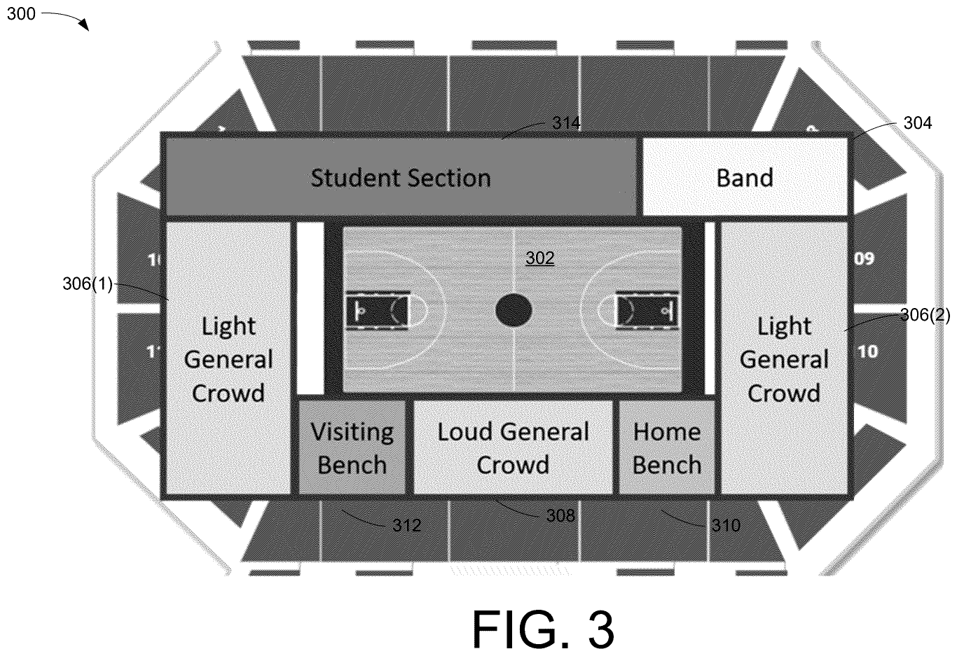

FIG. 3 is a diagram of an example configuration of spatial objects from an IMRA system overlaid on a basketball arena 300 configuration. The illustrated basketball arena 300 configuration includes spatial objects as may be expected associated with a basketball game, and can include acoustics associated with a particular arena or event. Other configurations are possible, expected, and being implemented. An IMRA system as described herein can produce sounds associated with illustrated spatial objects and their relative location to the basketball court 302, and the spatial objects and corresponding locations can be revised, reconfigured, and/or omitted. In the illustrated example, a band section 304 is presented in an upper-right corner of the diagram, and the IMRA system can be configured to present sound corresponding to a pep band associated with that location. The IMRA system can be configured to present light general crowd noise from locations where general spectators would be seated, e.g., 306(1) and 306(2). The IMRA system can be configured to present loud general crowd noise from locations where general spectators would be seated closer to the players or based on acoustics of a particular arena, e.g., 308. The IMRA system can be configured to present noise from a home bench section 310 such as shouts of encouragement to the player, groans if the player misses a shot, etc. The IMRA system can be configured to present noise from a visiting bench section 312 such as trash talking or taunting, and cheers when the player misses a shot, etc. The IMRA system can be configured to present noise from a student section, e.g., 314, such as loud organized cheers and chants, etc.

Various audio devices can be a part of, used by, associated with, and/or combined to output the audio generated by an IMRA system. A non-exclusive list of example audio devices that an IMRA system can include are: venue loudspeakers, portable loudspeakers, headphones, earbuds, multi-speaker arrays, spatial audio wearables, etc.

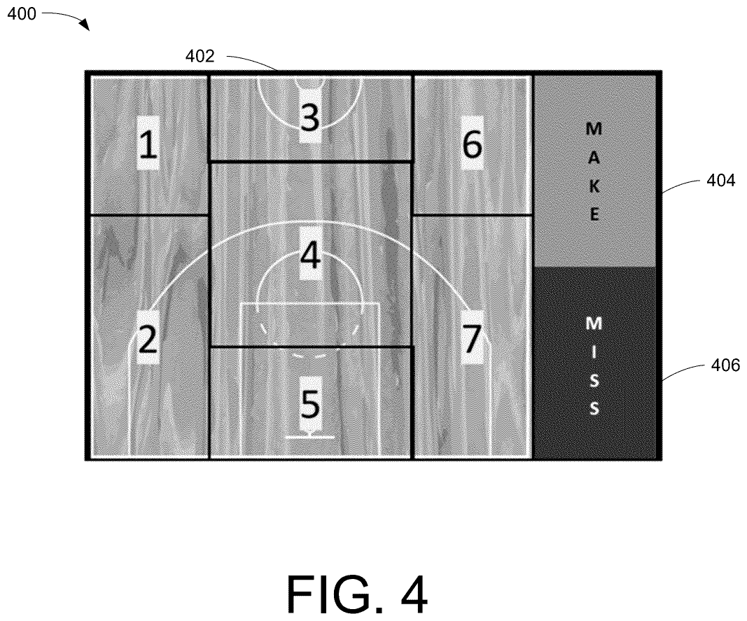

FIG. 4 is a diagram of an example user interface 400 for configuration of spatial objects from an IMRA system on part of a basketball court 402. An IMRA system as described herein can be configured (or can be associated with additional components) to detect user actions and/or outcomes, such as detecting whether the user is located closest to location 1 to 7 on the court 402. In at least one example, a user can make a determination of whether an action and/or outcome occurred, and an IMRA system can receive a manual input of the user's determination via a controller and/or graphical user interface, such as via receiving a selection of “make” 404 or “miss” 406. In some examples, an existing system can be configured to detect and/or record certain actions and/or outcomes. In some examples, an IMRA can be configured to integrate with a third-party product to detect and/or record certain actions and/or outcomes. In various examples, an IMRA system can obtain data from a physical training and/or gaming environment and can send the obtained data to a program (e.g., an experience engine, a game engine, etc.), which can use this data to create an interactive mixed reality audio environment.

Below are examples of methods that an IMRA system can use to detect actions and/or outcomes. One or more of these can be combined in various examples.

In at least one example scenario, an existing action/outcome technology can include an application used by an operator that logs where a user is on a virtually rendered physical environment and whether certain actions/outcomes have occurred. The data from the operation can be sent to an experience engine associated with the IMRA system.

In some instances, a user can use a manual operation of IMRA to experience a sample of the sound in the designed audio environment. In some examples, when combining IMRA with a graphical representation of a physical space, the IMRA can be manually operated to experience sound in specific locations in the physical space, e.g., any of locations 1 to 7 associated with court 402. In some examples, the experience of the physical space can be configured to have 3dof or 6dof interaction in the physical space. In some examples, the realistic sound of the physical space can be augmented with fictional sounds and objects. The IMRA system can capture inputs from movements and/or receive manual inputs to produce a virtual audio environment that the user can interact with such as hearing simulated concert sounds associated with selected seat locations.

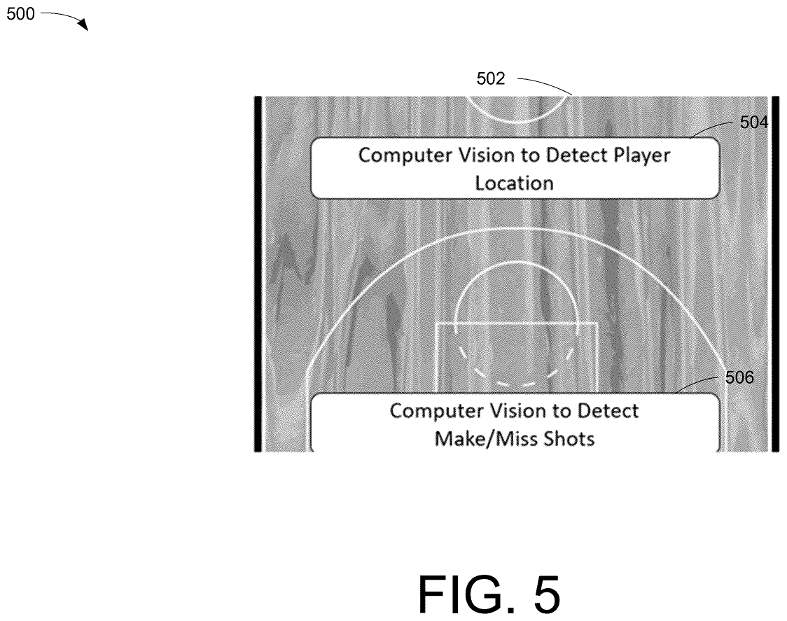

FIG. 5 is a diagram 500 of an example part of a basketball court 502 to illustrate configuration of spatial objects from an IMRA system employing computer vision. Computer vision can detect player locations, 504. Computer vision can detect whether a shot was made or missed, 506. In at least one example scenario, cameras and/or computer vision can be used with methodologies including, for example, LiDar or convolution neural network (CNN) modules to implement various machine learning algorithms that have been trained to determine location, gestures, poses and/or outcomes (e.g., YoloV4). An IMRA system can use the resulting data as inputs to create an interactive audio experience, which can include a new interactive audio experience and/or enhance some conventional technologies that track user movements and/or outcomes such as SecondSpectrum, PlaySight, HomeCourt for basketball. Computer vision incorporated into an IMRA system as described herein can recognize a series of motions, pose estimation, and/or posture change flow, for example, to ascertain a user action and resulting outcome. An example application of this method can include providing immersive crowd audio reactions to user actions and/or outcomes in a ball game. In examples, the use of computer vision to achieve said outcomes can be enacted in a fixed physical space. An additional use of computer vision in an IMRA system can include using computer vision to map a physical space and/or to place one or more audio objects in predetermined and/or variable locations.

In at least one example scenario, sensors other than cameras can be associated with IMRA technology and/or an IMRA system can be integrated in training devices (e.g., ball, bat, golf club, etc.) and/or into wearables, which can communicate with transceivers that IMRA technology can use to create a 3-dimensional rendering of the environment and sensor tracking. These sensors can be tied to audio objects and can serve as inanimate fixed objects with audio characteristics and/or animate objects that move in space. An example of an inanimate fixed object can include the audio of a fire set ablaze when a user performs a certain action, and an application of an animate object can include a defender in a ball game that can react to a sports player's moves. In some examples, sensor-based methods can employ additional hardware beyond a conventional mobile device.

Bluetooth proximity estimation can present a flexible option for users of IMRA technology as described herein. Bluetooth earbuds, which can include spatial audio capabilities, can offer data inputs for mixed reality interactive physical audio. For the purposes of user tracking, position and movements can be approximated using events from a gyroscope and/or accelerometer incorporated into a variety of Bluetooth devices. IMRA technology can process data using deep learning methods, by which an IMRA system can become predictive in its approach to tracking user movement and location. With this tracking, a user need not be geographically bound within vision of a camera, as long as the user stays in proximity of their Bluetooth device. In examples of data-enabled headphones, earbuds, AR glasses, headset, etc., or for example headphones, earbuds, AR glasses, etc. associated with another data-enabled wearable such as an APPLE watch. For example, a user can operate from their earbuds, providing an experience untethered from a phone. In some examples, a user using an IMRA system and equipped with a data-enabled device, such as data-enabled earbuds, headphones, AR glasses, headset, smart watch, phone and/or tablet, can allow the IMRA system to track the user through a physical space using technologies such as Bluetooth, GPS and/or calculations from an accelerometer and/or gyroscope. An IMRA system can assess actions associated with the user via one or more of the methods discussed previously and can present location-specific audio. In examples, an IMRA system can pair user actions, GPS, and/or geofencing and, based on those inputs, present dinosaur noises in a specific forest in an audio-based, Jurassic Park type game. In some examples, an IMRA system can pair user's actions, GPS, and/or geofencing and, based on those inputs, present spatialized audio branded objects while on a run or walking tour. Many other types of games and scenarios are contemplated, some of which are described herein.

An IMRA system can be associated with sensors, e.g., on wearables, to collect biometric data including heart rate, blood oxygen levels, and/or voice, etc. The IMRA system can use analysis of one or more of these metrics as inputs into the system, e.g., an associated experience engine, which in turn, the IMRA system can use to modify the audio environment. In some examples, data-enabled headphones, earbuds, AR glasses, headset, etc. can include microphones and/or other sensors to capture events, motion, audio, etc. and provide associated signals to components of an IMRA system for motion tracking, event detection, etc. In various examples, data-enabled headphones, earbuds, AR glasses, headset, etc. can include speakers to modify the audio environment. In examples, if a user is training to keep calm during an intense part of a game, the intensity of the environment can be initially set to high via the IMRA system and based on the user's performances and associated reactions measured from their heart rate, the IMRA system can increase or decrease intensity of the audio environment. As the user improves their ability to stay calm while performing, the IMRA system can present certain audio rewards.

This location, action and outcome data can be used as inputs to create new interactive audio experiences or to enhance conventional technologies such as ShotTracker for basketball.

An IMRA system as described herein can be configured for single player, multiple players in the same geographical location, and/or multiple players in separate geographical locations. In examples, an IMRA system can create a fictional, non-fictional, or combination fictional/non-fictional environment that can produce audio stimulus that can improve user(s)' training/game environment and/or can improve user(s)' future performance.

In examples, a user can configure an IMRA system to select:
Type(s) of actions/outcomes for the IMRA system to detect (e.g., free throw shooting, putting, target practice, etc.).
A type of audio environment from the IMRA system that the user wants to perform in (e.g., realistic desired performance environment, non-fictional desired performance environment, fictional desired performance environment, mixed environment, preconfigured environment, customized environment, selected scenario)
An audio output technology associated with the IMRA system and/or the user (e.g., loudspeaker, headset, earbuds, spatial earbuds, etc.).

In an example, the IMRA system can then initialize the audio environment and wait until a sensor associated with the IMRA system detects one or more actions and/or outcomes, and based on the detected actions and/or outcomes, the IMRA system can dynamically change the audio environment in which the user is performing. The player can perform actions that can have associated outcomes, and the outcomes can create unique inputs into the IMRA system that the IMRA system can process to create a mixed reality pairing, that is an interactive audio environment paired with the user's physical environment (and actions).

In an example single user scenario, the user can interact directly with an IMRA system. The IMRA can dynamically change audio and/or provide feedback based on the user performing actions.

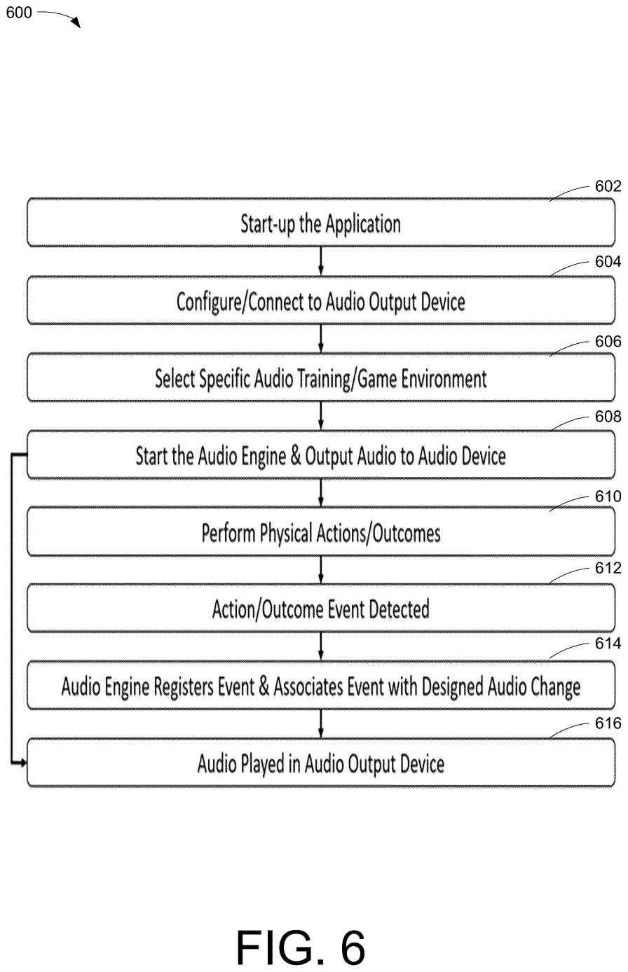

FIG. 6 is a flow chart with example operations associated with an IMRA system as described herein. Block 602 represents initiating an IMRA application. Block 604 represents configuring an audio output device to work with the IMRA application and/or connecting to a so configured audio output device to output audio from an IMRA system. Block 606 represents receiving a selection of an audio training or game environment. Block 608 represents initiation of an audio engine and providing audio to an audio device for output. Block 610 represents one or more sensors associated with the IMRA system identifying performance of physical actions/outcomes. Block 612 represents one or more sensors detecting that a physical action has been performed and/or an outcome completed. Block 614 represents an audio engine associated with the IMRA system registering an event and associating the event with designed audio, which differs from the audio output at block 608. Block 616 represents the IMRA system providing the designed audio to be played by an audio output device.

In examples, selecting a specific audio training/game environment can include multiple steps. For example, a user can specify which game they want to play, a level of difficulty, and/or a specific audio environment. For example, a basketball player can select “beat the pro” as their game and set their level of difficulty to be easy. In some examples, steps shown in FIG. 6 can be executed in a separate system that is integrated with the IMRA (e.g., application startup, configuration, game selection, event/outcome detection can occur in a separate application that communicates with the IMRA to produce the audio experience).

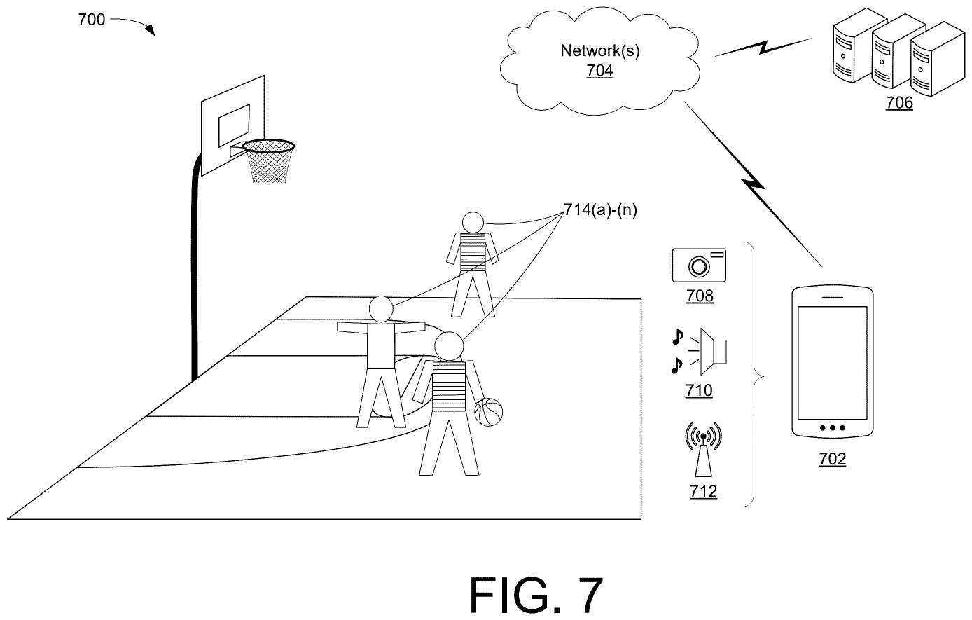

FIG. 7 illustrates an example environment 700 with various components associated with an IMRA system, such as for single-output audio. As shown, a user electronic device 702 communicates over the network(s) 704 with the computing resource(s) 706 to facilitate the IMRA system. The user electronic device 702 can include a camera 708, speakers 710, and one or more wireless communication interface(s) 712.

In some examples, the user electronic device 702 can execute an application associated with the IMRA system to give one or more users 714(a)-(n) an immersive and interactive mixed reality audio experience. For instance, the user electronic device 702 can include a processor, and the application can store computer-readable media that causes the user electronic device 702 to capture, with the camera 708, image data associated with the one or more users 714(a)-(n) in the practice, game, and/or performance environment 700. In some examples, based on the captured image data, the application running on the user electronic device 702 can determine an action of the one or more users 714(a)-(n) that is associated with an athletic activity. The application can then cause the user electronic device 702 to send, over the network(s) 704, an input corresponding with the action to the computing resource(s) 706. In response to receiving the input from the user electronic device 702, the computing resource(s) 706 can identify changed audio associated with the action and cause the user electronic device 702 to output the changed audio via the speakers 710 into the practice, game, and/or performance environment 700 such that the one or more users 714(a)-(n) experience the immersive and interactive mixed reality audio experience.

In various examples, the user electronic device 702 can include a smartphone, a tablet, a laptop computer, a voice-enabled device, a smart camera, or another personal electronic device. In some examples, a user electronic device 702 may comprise one or more user electronic devices. The user electronic device can include one or more user interface components and/or input/output components, such as a touchscreen. In some examples, the user electronic device 702 can operate in an offline mode to provide the augmented audio conditioning experience. The user electronic device 702 can store the modules of the IMRA application and/or system described herein in local memory, such as an environment learning module, an action detector module, an audio experience generator module, an audio environment transmitter module, an archiving and/or reporting tool module, and a user interface module. Additionally, or alternatively, the user electronic device 702 can store audio conditioning data files in a local memory.

In some examples, the camera 708 of the user electronic device 702 can capture images and/or video associated with the one or more users 714(a)-(n) (where n represents any number greater than or equal to one) in the conditioning, game, and/or performance environment 700. In some examples, an individual user can be in a physical location, and one or more other users can represent audio objects, mannequins, etc. In some examples, the camera 708 can serve as an image sensor for the IMRA system. In some examples, the speakers 710 of the user electronic device 702 can output audio into the practice, game, and/or performance environment 700.

In some examples, the user electronic device 702 can include an integrated camera and/or speaker, such as camera 708 and speaker 710. However, in some examples the camera 708 and/or speaker 710 can be stand-alone hardware devices that are communicatively coupled to the user electronic device 702 via a wired and/or wireless connection. For instance, the user electronic device 702 can utilize a wireless communication interface 712 to facilitate communication between camera 708 and/or speakers 710. As such, in some examples, the speaker 710 can include headphones or earphones worn by the one or more users 714(a)-(n) who desire to train or perform with the IMRA experience. In some examples, the user electronic device 702 can include one or more microphones to provide audio data inputs to the IMRA system.

In some examples, the one or more wireless communication interface(s) 712 of the user electronic device 702 can enable the user electronic device 702 to communicate with the computing resource(s) 706 over the network(s) 704. Additionally, or alternatively, the wireless communication interface(s) 712 can enable the user electronic device 702 to communicate with peripheral devices, such as camera 708 and/or speaker 710. For instance, the user electronic device 702 can utilize the wireless communication interface(s) 712 to establish a Bluetooth communication channel with at least one of the camera 708 and/or the speaker 710.

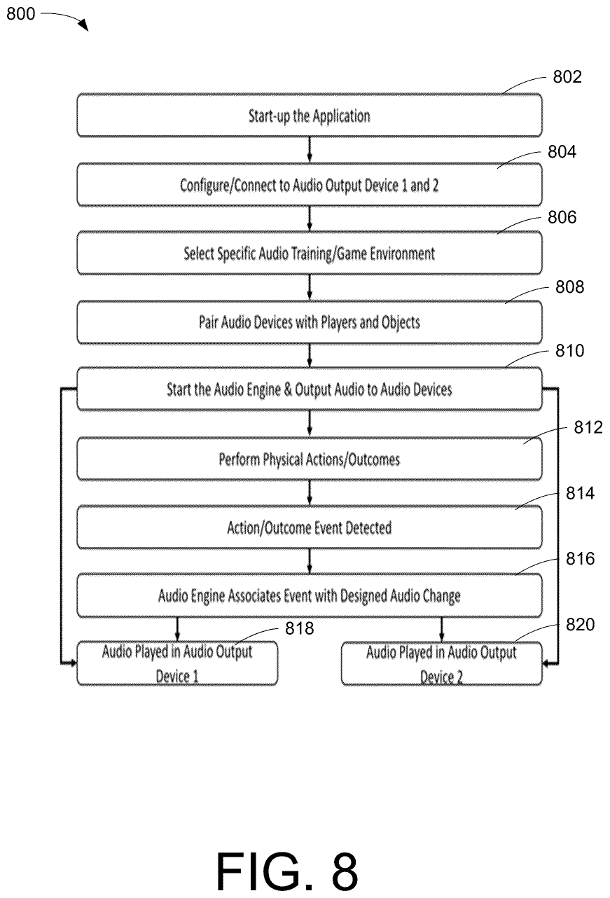

FIG. 8 is a flow chart with example operations associated with an IMRA system as described herein. Block 802 represents initiating an IMRA application. Block 804 represents configuring at least a first audio output device and a second audio output device to work with the IMRA application, connecting to at least two so configured audio output devices to output audio from an IMRA system, and/or configuring at least one audio output device to work with the IMRA application and connecting to at least one so configured audio output device to output audio from an IMRA system. Block 806 represents receiving a selection of an audio training or game environment. Block 808 represents pairing at least the first and second audio devices with respective of the players and/or objects. Block 810 represents initiation of an audio engine and providing audio to the audio devices for output. Block 812 represents one or more sensors associated with the IMRA system identifying performance of physical actions/outcomes by the player associated with the first or second audio output device. Block 814 represents one or more sensors detecting that a physical action has been performed and/or an outcome completed. Block 816 represents an audio engine associated with the IMRA system registering an event and associating the event with designed audio for the first or second audio output device, which differs from the audio output at block 810. Block 818 represents the IMRA system providing the designed audio for the first audio output device to be played by the first audio output device. Block 820 represents the IMRA system providing the designed audio for the second audio output device to be played by the second audio output device.

In an example multi-user scenario, two or more users can perform in a shared physical location environment, and the IMRA system can provide the two or more users individual (unique) or shared (the same) audio experiences based on the two or more users performing actions. In at least one example, a shared audio experience can be spatially tailored to the locations of the specific users within the shared environment. In other instances, two more users can perform in separate physical locations, and the IMRA system can provide the two or more users individual (unique) or shared (the same) audio experiences based on the two or more users performing actions.

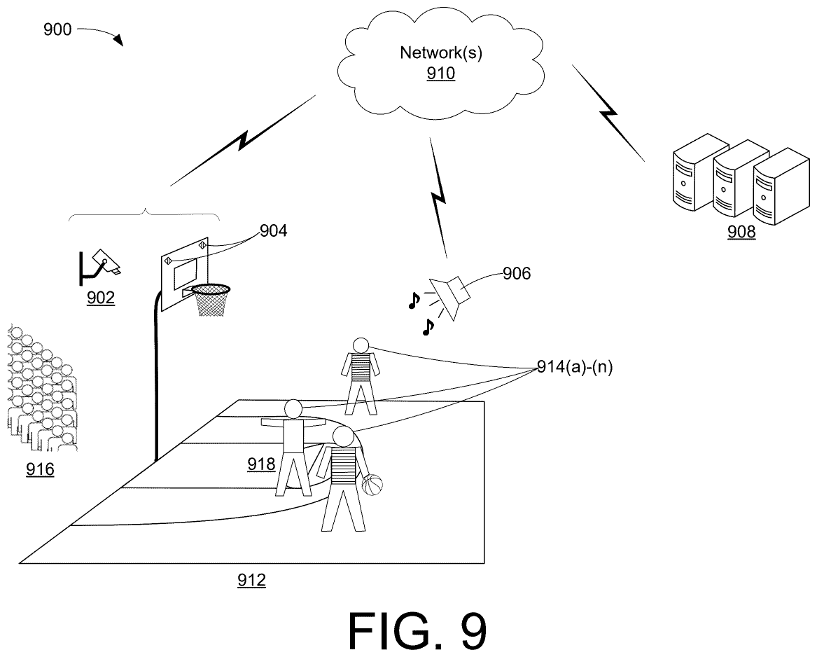

FIG. 9 illustrates an example environment with various components associated with an IMRA system. As shown, the environment/architecture 900 includes an image sensor 902, a binary input sensor(s) 904, a speaker 906 (which in some instances can correspond to speaker 710, FIG. 7), and computing resource(s) 908 (which in some instances can correspond to computing resource(s) 706, FIG. 7). The network(s) 910 (which in some instances can correspond to network(s) 704, FIG. 7), can facilitate communications between the computing resource(s) 908, the image sensor 902, the binary input sensor(s) 904, and/or the speaker 906. Further, the image sensor 902, binary input sensor(s) 904, and speaker 906 can be disposed in an environment 912 (which in some cases can be a practice, game, or a performance environment absent many or most spectators) in which one or more users 914(a)-(n) (which in some instances can correspond to user(s) 714, FIG. 7), can train, play, and/or perform.

In various examples, the image sensor 902 can include a camera (which in some instances can correspond to camera 708, FIG. 7), that is capable of recording videos and/or still images. In some examples, the image sensor 902 can include a plurality of image sensors to collect image data of the users 914(a)-(n) training or performing in the practice, game, and/or performance environment 912. A plurality of image data can be captured at the same time and from different angles such that the IMRA system can detect multiple actions of the one or more users 914(a)-(n). As a result, the IMRA system can generate different audio conditioning data outputs for the multiple actions of the users. In some examples, the image sensor 902 can capture and/or send image data over the network(s) 910 to the computing resource(s) 908. In at least one example, the image data may include a video and/or a photographic image.

In some examples, the binary input sensor(s) 904 can capture binary input data associated with specific events. For instance, binary input sensor(s) can capture data that indicates whether a basketball shot was made (or missed), whether a goal was scored, whether a user is in a specific area of the conditioning, game, and/or performance environment, etc. As such, the binary input sensor(s) 904 can include a proximity sensor, a pressure sensor, a motion sensor, an occupancy sensor, a microphone, etc. In some examples, the binary input sensor(s) 904 can capture and/or send sensor data over the network(s) 910 to the computing resource(s) 908.

In various examples, the speaker 906 can output audio data, such as audio conditioning data, into the conditioning, game, and/or performance environment 912. The speaker 906 can be in communication with the computing resource(s) 908 via the network(s) 910. The speaker 906 can include a network of speakers that are strategically disposed in the practice, game, and/or performance environment 912 such that the audio conditioning data appears more realistic to the one or more users 914(a)-(n).

In various examples, the computing resource(s) 908 can include processors, memory, operating systems, input/output interfaces, network interfaces, and other hardware components, or any combination thereof. In some examples, the computing resource(s) 908 can perform various machine-learning and/or image processing techniques. In some examples, the modules of the IMRA system described herein, such as an environment learning module, an action detector module, an audio experience generator module, an audio environment transmitter module, an archiving and/or reporting tool module, and a user interface module, can be instantiated on the computing resource(s) 908.

In some examples, the network(s) 910 can facilitate communications between the computing resource(s) 908 and the image sensor 902, the binary input sensor(s) 904, the speaker 906, and other input and/or output devices associated with the practice, game, and/or performance environment 112. The network(s) 910 can include a network of wired and/or wireless connections. The network(s) 910 can include a Personal Area Network (PAN), Local Area Network (LAN), Wireless Local Area Network (WLAN), Campus Area Network (CAN), Metropolitan Area Network (MAN), Wide Area Network (WAN), System-Area Network (SAN), cellular network, etc. In some examples, data can flow from device to device over the network(s) 910 bi-directionally. In other examples, the data can flow uni-directionally from device to device.

In various examples, environment learning data can include audio and/or video data files corresponding to desired performance environments. For instance, the environment learning data can include video data with corresponding audio data of a basketball game played at McCarthey Athletic Center, a football game played at Century Link Field, a baseball game played at Safeco Field, and/or another activity. In some examples, resulting audio objects can correspond to spectators, other players, famous players, etc. Resulting audio objects can correspond to crowd noises of spectators 916 at athletic and/or performance events. For instance, the crowd noise from spectators 916 can include applause, booing, cheering, and/or general crowd noise. In some examples, resulting audio objects can correspond sounds from players/athletes/performers 918 at athletic and/or performance events. For instance, the sounds from players/athletes/performers 918 can include praise, exclamations, congratulations, boos, taunting, trash talking, etc.

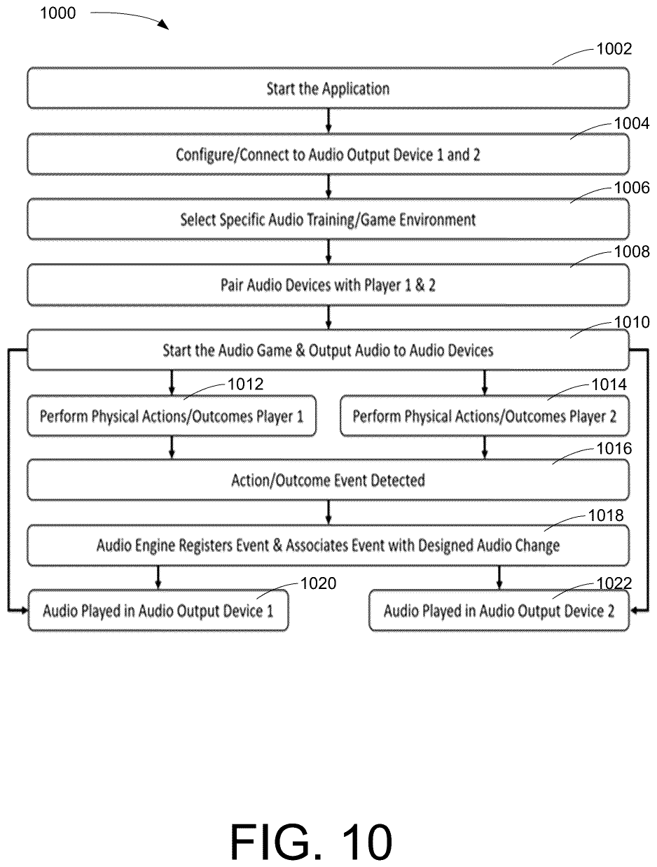

FIG. 10 is a flow chart with example operations associated with an IMRA system as described herein. Block 1002 represents initiating an IMRA application. Block 1004 represents configuring at least a first audio output device and a second audio output device to work with the IMRA application, connecting to at least two so configured audio output devices to output audio from an IMRA system, and/or configuring at least one audio output device to work with the IMRA application and connecting to at least one so configured audio output device to output audio from an IMRA system. Block 1006 represents receiving a selection of an audio training or game environment. Block 1008 represents pairing at least the first and second audio devices with respective of the players and/or objects. Block 1010 represents initiation of an audio engine and providing audio to the audio devices for output.

Block 1012 represents one or more sensors associated with the IMRA system identifying performance of physical actions/outcomes by the player associated with the first audio output device in a first location. Block 1014 represents one or more sensors associated with the IMRA system identifying performance of physical actions/outcomes by the player associated with the second audio output device in a second location. Block 1016 represents one or more sensors detecting that a physical action has been performed and/or an outcome completed at least one of the first or second location. Block 1018 represents an audio engine associated with the IMRA system registering an event and associating the event with designed audio for the first or second audio output device, which differs from the audio output at block 1010. Block 1020 represents the IMRA system providing the designed audio for the first audio output device to be played by the first audio output device. Block 1022 represents the IMRA system providing the designed audio for the second audio output device to be played by the second audio output device.

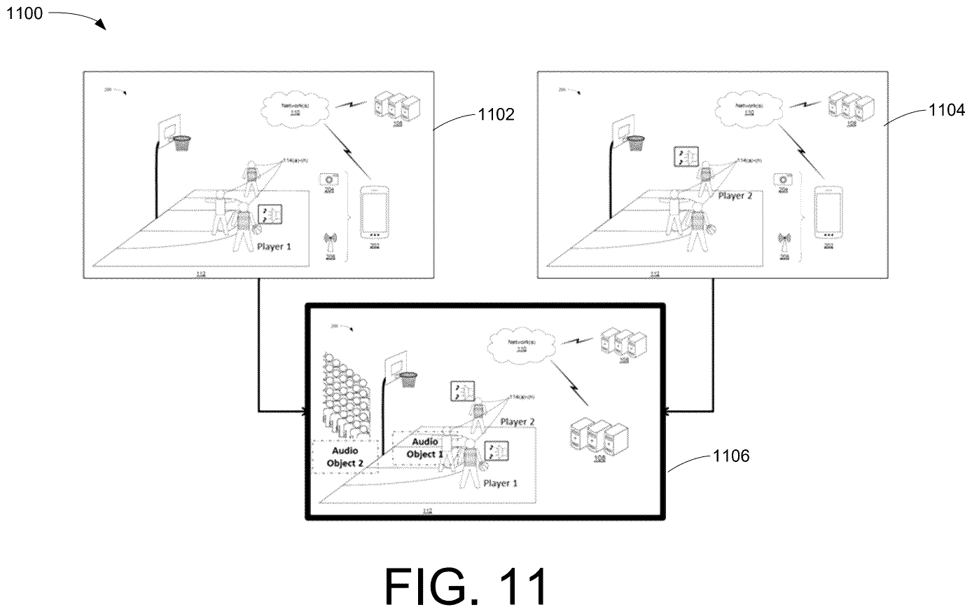

FIG. 11 illustrates an example multi-user, multi-location environment with various components associated with an IMRA system. As shown, the example multi-user, multi-location environment/architecture 1100 includes a first environment 1102 and a second environment 1104. In various examples, the first environment 1102 and/or the second environment 1104 can correspond to environments 700, FIG. 7, and/or 900 and/or 912, FIG. 9, And include components as described regarding FIGS. 7 and 9. The IMRA system can combine environments 1102 and 1104 to create a combined environment 1106, which can also be augmented with audio objects not present in environments 1102 and 1104.

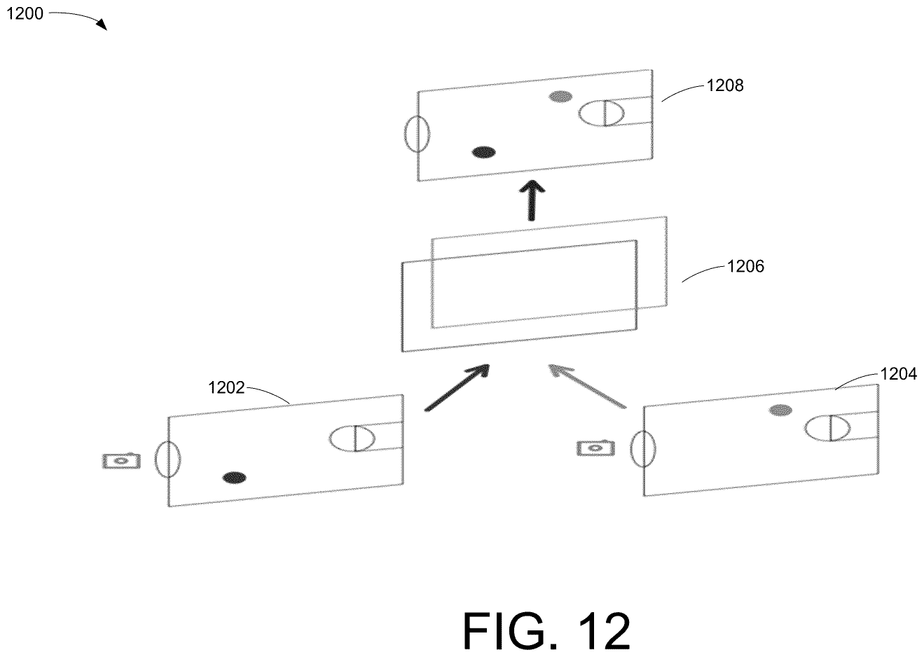

FIG. 12 illustrates an example of how environments associated with a multi-user, multi-location IMRA system can be superimposed together at 1200. As shown, first environment 1202 and second environment 1204 can be superimposed one onto the other at 1206 to create a combined environment 1208. In various examples, the first environment 1202 and/or the second environment 1204 can correspond to environments 700, FIGS. 7, 900 and/or 912, FIG. 9, and/or 1102, 1104, and/or 1106, FIG. 11, and include components as described regarding FIGS. 7, 9, and 11. The IMRA system can augment environment 1208 with audio objects not present in environments 1202 and 1204.

In at least one example multi-user scenario, two or more users can connect to an IMRA system from multiple locations to share a common virtual environment. This connection can be synchronous or asynchronous. In some examples, the IMRA system can provide the two or more users individual (unique) or shared (the same) audio experiences based on the two or more users performing actions. In some examples, one or more of the users can manually (via an input to the IMRA system) position themselves in the audio environment, while in some examples sensors associated with the IMRA system can detect positioning (location and rotation of one or more users in the audio environment). An IMRA system can reproduce audio associated with one or more of the users in a shared virtual soundscape.

A shared virtual soundscape can include a virtually rendered environment where two or more users'physical environment can be superimposed onto a common virtual environment. In examples: Physical data from User A can be paired with audio data from User A and localized as audio objects in the virtual soundscape (synchronously or asynchronously). Physical data from User B can be paired with audio data from User B and also localized as audio objects in the virtual soundscape (synchronously or asynchronously). Users behavior and outcomes can be determined by a CPU associated with the IMRA technology. The IMRA system can provide associated data for presentation to the appropriate user(s)' audio space. More simply put, the IMRA system can generate a common virtual environment such that user A can experience their physical environment as if the audio object of user B is in user A's physical environment, and user B can experience their physical environment as if the audio object of user A is in user B's physical environment.

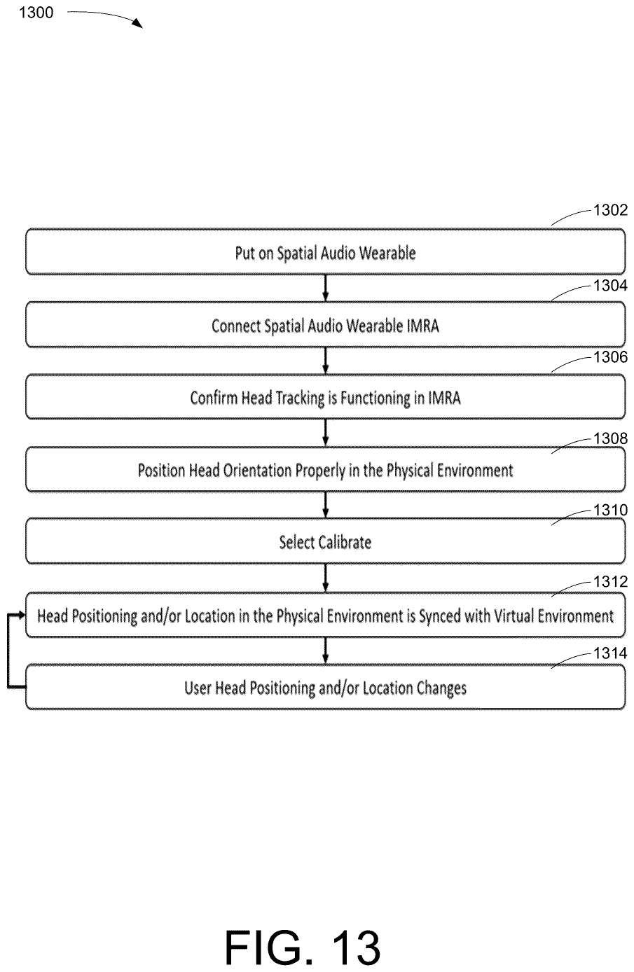

FIG. 13 is a flow chart with example operations 1300 associated with an IMRA system as described herein. When an IMRA system is configured to immerse a user in a spatially enabled audio environment using a spatially enabled audio wearable that adjusts the audio environment based on the head rotation and/or location of the user in the physical/virtual environment, the configuration processes can include calibrating the audio environment to include the user. In an example, the user puts on the wearable 1302 and connects the wearable into the IMRA system 1304 with the system being able to track the head positioning of the user. The system can provide a request that the user point their head in a specific direction with a specific rotation 1306 (e.g., stand at the free throw line and look at the basket) and provide a prompt for input when the user is so positioned 1308. When the user is set in the right position, they can select the calibration option 1310. The IMRA system can sync the users'location and positioning in the physical environment with their location and positioning in the virtual audio environment 1312. Virtual audio objects that are designed into the audio environment can obtain a virtual location in the physical space 1314.

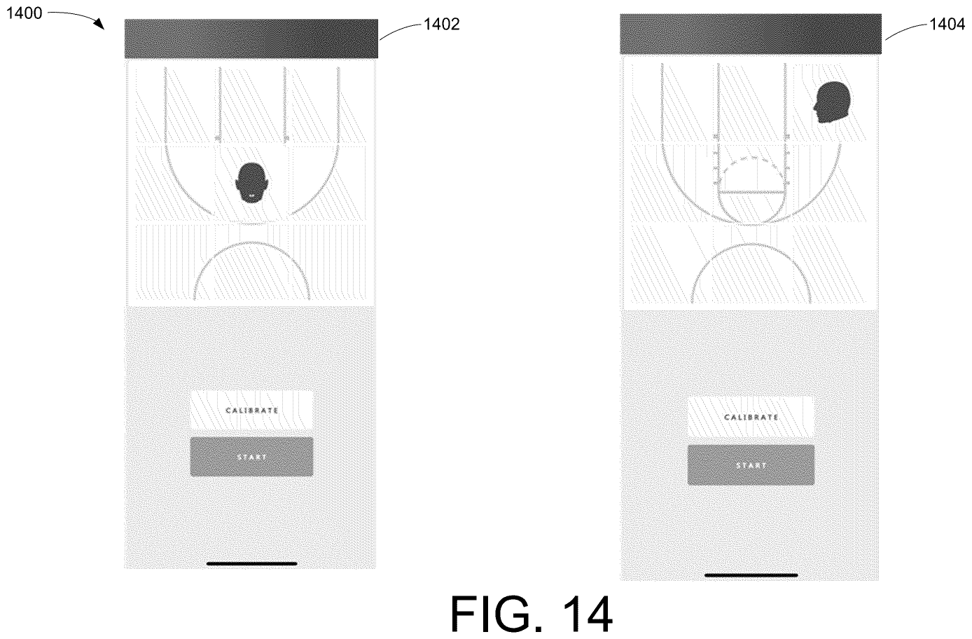

FIG. 14 illustrates an example user interface 1400 that an IMRA system as described herein can present during the configuration process. For example, the IMRA system can provide the user interface to calibrate the audio environment to include the user. As shown, the user interface 1400 includes a first representation of environment 1402 in which the user is located at the free-throw line and facing away from the basket. As shown, the user interface 1400 includes a second representation of environment 1404 in which the user is located at the right base line and facing toward the basket. In various examples, the environments presented in user interface 1400 can correspond to environments 700, FIGS. 7, 900 and/or 912, FIGS. 9, 1100, 1102, 1104, 1106, FIG. 11, and include components as described regarding FIGS. 7, 9, and/or 11. Since the IMRA system is able to track the changes in head rotation and/or location of a user, as the user changes their rotation in their physical environment (e.g., looks away from the basket as shown in 1402) and/or moves in the physical space (e.g., baseline corner of the court as shown in 1404), the IMRA detects the change, updates the user's head rotation and/or location in the virtual scene and thus, updates the positioning of the virtual audio objects in proximity and orientation to the user. In examples, if an audio object is placed behind the basketball hoop, when the user is looking at the hoop, the sound comes from the front of the user, but when the user's head is turned to the right, the sound continues to come from the direction of the hoop which will now be towards the left of the user's head.

While figures have been provided showing examples of IMRA technology associated with basketball; other sports training and/or games, police/law enforcement training and/or games, firefighting training and/or games, and/or health and wellness exercises are additional example contexts in which IMRA technology as described herein can be useful. Examples are merely truncated for brevity, and the examples throughout are not intended to be exclusive.

IMRA technology in an IMRA system as described herein can be useful in various combinations of physical activities and associated interactive audio environments. Below are some examples of physical activities and audio experiences. An audio game can be integrated with an existing product or be fully functional as a stand-alone product and/or game. An IMRA system can produce an interactive audio environment that can be realistic, fictional or a combination thereof. Audio experiences and/or games can be built in tiers or levels such that a user can progress through different tiers or levels or even audio experiences based on prior achievements (e.g., move from one tier or level to another, move from one game to another, move from NCAA to NBA to NBA Playoffs, etc.).

In some examples, an audio experience using IMRA technology can be a standalone app, e.g., on a phone, tablet, etc., that can detect when a user recreates actions from an iconic event and/or series of events. The audio experience can recreate the audio environment from the event(s) and/or reward the user when the user performs actions like the iconic event(s).

As one, non-limiting, example, a basketball game can be designed around Tracy McGrady's 13 points in 33 seconds against the San Antonio Spurs in 2004. IMRA technology can monitor actions of a user and generate a similar audio environment according to the iconic event(s). An IMRA system can continue to reproduce an audio environment associated with advancing time of the iconic event(s), as long as the user continues to successfully mimic Tracy McGrady's actions, in this example. If the user misses a shot or if the user's body movement does not mimic Tracy McGrady during the event(s), the game can initialize back to the beginning of the event.

In some examples, an audio experience and/or game using IMRA technology can be a standalone app, e.g., on a mobile phone, tablet, etc., that can detect a user's actions and can provide an interactive audio game simulating a realistic experience.

In examples, an IMRA basketball free throw simulator can be deployed in which a camera is positioned, e.g., a mobile phone camera, to capture a basketball court including a basketball hoop. The user can open up an audio experience app and can select a free throw simulator. In some example, the user can configure the audio environment to be a hostile away game against a known team, e.g., a famous NBA team (e.g., LA Lakers with Lebron James) in which the user needs to make 2 free throws to send the game to overtime. In some examples, the system can be configured to connect to earbuds (e.g., earbuds with spatial capacity) and/or another speaker, and the IMRA technology can present a fully 6dof spatial audio rendering of an end of game scenario at a rival's home gym via the spatial earbuds and/or a speaker.

The IMRA system can produce sounds of the opposing team talking to the user from positions where opposing players wait (e.g., block, low post, high post) while the user/free-throw shooter walks to the free-throw line and prepares to shoot their free throw. An IMRA system can be configured to provide known people's or character's voices. In examples, the IMRA system can produce sound for the user to hear Lebron James trying to distract them and break their concentration. In some examples, the user can hear a spatially rendered crowd yelling and stomping their feet. If the user shoots their first free throw and makes it, the produced crowd sound can include a collective sigh and the crowd can seem to become quiet while the user's teammates and accompanying fans cheer. If the player misses, the produced crowd sound can include sound of the crowd celebrating the opposing team's win. But if the user makes the first shot, after a predetermined time passes, e.g., 3-6 seconds, the produced sound can include the crowd and/or opposing team starting to get loud, distracting, and/or hostile, setting the scene for the second and final free throw. The user can prepare her/his shot routine and shoot another free throw. If the shot misses, the system plays the opposing team's celebration and if the shot goes in, the IMRA system can produce an audio environment of the user's team and fans congratulations and/or celebration, which in some examples can be spatially rendered so that the team, for example, can seem to come from the location of the team bench and move toward the user.

In examples, an audio experience and/or game using IMRA technology can be associated with another application and/or system configured to detect and track certain behaviors and outcomes. The audio experience and/or game can connect to the other system and can perform operations based on output data sent from any associated action/outcome detection system. Based on the data received, the IMRA technology can configure the audio experience and/or game to provide an interactive fictional audio environment (whether based on a recognizable fictional environment, such as a movie, song, etc. or completely new) that dynamically changes.

As one non-limiting example, a soccer experience and/or game can integrate audio environment from the video game Call of Duty into the training of kicking corner kicks. A loudspeaker can be configured for an associated IMRA system and positioned in the corner kick area where the user will be training. The IMRA system can provide a variety of sounds and receive a selection of one or more sounds for the audio environment. In examples, selection of the hand grenade game from the Call of Duty audio environment. Associated camera(s) and/or other sensor(s) can be set to monitor a soccer ball being kicked from the corner location. The IMRA system can provide predetermined sounds, changes in the audio environment, based on the kicked ball's trajectory and landing area.

In examples, after receiving selection of the game settings, a loudspeaker can start to play the Call of Duty audio environment, and as the user kicks a ball, based on the trajectory of the ball, the IMRA technology can provide the sound of a hand grenade flying in the air (in the form of a cinematic trope which is a fictional sound to be registered by the user as the sound of a hand grenade flying in the air) and landing. If the ball lands in an undesirable location, the explosion sound can be minimal and distant. If the ball takes a desired trajectory such that it lands in the desirable location, a loud explosion sound from Call of Duty can occur.

In some examples, an audio experience and/or game using IMRA technology can be associated with another application and/or system that can detect a user's actions and/or outcomes and that can provide an interactive audio experience and/or game based on a combination of realistic and fictional experiences.

In examples, a golfing putting experience and/or game can integrate with an app (e.g., Putt Vision). The app can include a mobile application that can track a putt's trajectory and determine if a putt was made. An IMRA system can use this information in conjunction with the audio experience and/or game to communicate the putt's probability of going into the cup and to sense the outcome (made/missed) to modify the audio environment.

In one non-limiting example, speaker(s) (e.g., loudspeaker, earbuds, etc.) can be associated with and/or have IMRA technology and connected to a putting application. The IMRA technology can provide a variety of sounds and receive a selection of one or more sounds for the audio environment. In examples, selection of an audio environment that mixes crowd reactions and fictional outcomes of a cash register for made puts and a whammies sound from Press Your Luck or a buzzer for missed putts. Associated camera(s) and/or other sensor(s) can be positioned to capture the putts on the practice green from a selected desired starting point and hole.

As the user putts their ball, the IMRA technology can produce crowd noise, which the speaker(s) can present. The volume can get increasingly louder as the probability of the putt going in increases. If the putt goes in, the IMRA technology can produce, and the speaker(s) can present audio output of a cash register (“cha-ching”) and/or the crowd applauding. If the putt is missed, the IMRA technology can produce, and the speaker(s) can present audio output of the crowd being disappointed, e.g., a groan, and/or the whammies sound from Press Your Luck and/or a buzzer. The produced and/or presented crowd reaction can intensify (either positively or negatively) as repeated outcomes occur (e.g., as more putts are made in a row, the crowd noise can become louder and if more putts are missed in the row, the crowd can seem to become less engaged).

In some examples, an audio experience and/or game using the IMRA technology can integrate with an app that tracks a user's physiological states and/or movement (e.g., running app, hiking app). In examples, the IMRA can be configured to provide audio at certain locations of a route (e.g., notification from a celebrity that they are halfway through their run, etc.). In examples, the IMRA can be configured to provide audio feedback to the user when their heart rate gets above or below a pre-determined level, when their stride is above or below a certain length and/or pace, etc. In examples, the IMRA can utilize data tracked on an exercise band to customize an audio environment that provides guidance on how much longer the user should run to achieve the selected number of calories burned for the run. In some examples, the IMRA can provide an audio tour while on a run or hike. For example, a user can go on a run through a city and get historical information about points of interest throughout the run. This information can be further spatialized to provide more detail. In some examples, the IMRA can be used to spatialize another runner (live or pre-set) in the audio environment to mimic another user running with them.

In some examples, an audio experience and/or game using IMRA technology can be a multi-party audio game that connects two users in physically different locations via a virtually rendered platform that can produce a shared audio environment, e.g., can reproduce a realistic sounding audio environment.

In examples, a two-party basketball game can be configured with IMRA technology such that two users, remote from each other, can virtually train and/or play together in a shared audio environment. IMRA technology can be deployed in devices, e.g., smart phones, tablet computers, etc., in the user's respective shooting environments including a hoop. In examples, the IMRA technology can provide known players for selection, and can receive selection of a player, e.g., a professional player, that the user(s) want to play as and/or which user will be the home player and/or away player in the shared experience. In examples, IMRA technology on a smart phone associated with user 1 can receive selection of Stephen Curry to be the home player and IMRA technology on a tablet computer associated with user 2 can select Chris Paul to be the away player. Both environments can include speakers, e.g., earbuds, headsets, other speakers, in some examples with spatial audio capabilities connected to the IMRA technology. The IMRA technology can configure the devices and/or speakers to communicate synchronously and/or spatially so that, for example, if user 1 is at the top of the key, sound can be produced in user 2's physical environment to seem that the audio from user 1 is coming from the top of the key. The IMRA technology can configure the devices and/or speakers to produce a shared audio environment in which, for example, the users can play a game of horse. If user 1 makes a shot, the IMRA technology can produce sound of a crowd responding positively, which can be played by speakers in both physical environments, and if user 2 makes a shot, the IMRA technology can produce sound of a crowd responding with disappointment, which can be played by speakers in both physical environments. The IMRA technology can keep track of the users'performance and can adjust intensity of the produced crowd reaction based on how close a user is to winning the game.

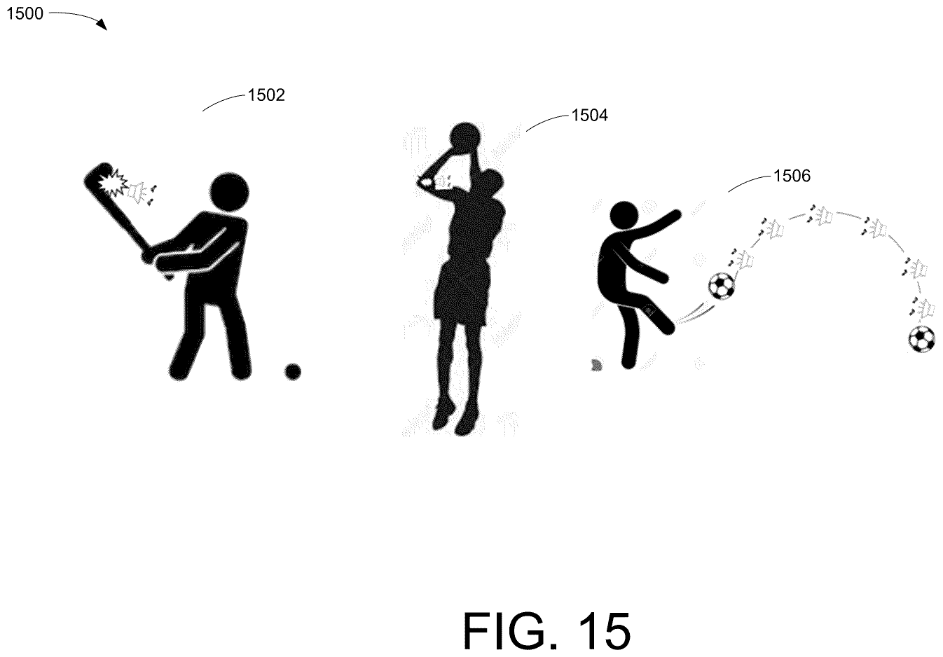

IMRA technology as described herein can be used as a tool to provide audio objects in the physical space around a user and/or to position audio objects associated with outcomes of events in the user's physical and/or virtual space. In examples:
An IMRA system can provide audio directional cues to users to position in a particular location and/or in a particular orientation to start or continue an audio experience.
   Spatialized Tour
      In examples, the IMRA can be associated with a pre-designed tour where monuments can be configured with specific geographic locations and a tour can be developed to utilize the GPS coordinates of the user and objects in combination with the 6dof positioning of the user. The user can move within the space and experience an interactive, spatialized tour where audio from objects are spatialized (e.g., the audio from or about President Lincoln is coming from the President Lincoln statue). In examples, audio objects can be used to direct a user from one point of interest to another (e.g., from one monument to another).
An IMRA system can provide location specific information based on event(s) occurring in a physical space. In examples:
   Golf
      If IMRA associated technology detects where/when a user's swing went wrong, the technology can use that location information to provide an audible indication of the error for presentation corresponding to the location. So, if at the top of a user's backswing, the club face is too open, a sound can seem to come from that location in space, to the user, to indicate that there is a problem in the swing, or in more detail, the club face is open at that part of the swing. This innovation is an example improvement over conventional mechanical clubs (e.g., Medicus) that merely break down at different parts of a person's swing.
      If an IMRA associated event tracker tracks the ball after it is hit, IMRA technology can receive this information and can generate and provide a corresponding sound (e.g., cinematic trope) associated with the path and/or spin rate of the ball, which can be presented by associated speaker(s), e.g., spatially. If the ball slices right, the sound of the ball slicing right can be presented. If the ball hooks left, the sound of the ball hooking left can be presented. If the ball spins are a high rate, a spinning sound associated with that spin rate is played.
      If IMRA technology detects poor posture of the user from an image provided by an associated sensor and/or camera, the system can provide general audio or specific spatial audio feedback for presentation via associated speaker(s) to guide the user to the correct posture (posture can be evaluated prior to, during and/or after the swing of the golf club).
      In some examples, IMRA technology can combine audio sounds to produce a unique sound for each movement so that a persons'swing can produce a unique sound and/or a desired sound for presentation. Further, any variation of the ideal swing can produce its own unique sound to indicate something that needs to be fixed.
   Basketball
      For example, if a user shoots a shot that is longer than perfect (e.g., hits the back of the rim first), IMRA technology can generate sound to be presented as coming from the front of the player. If the shot is shorter than perfect (e.g., the shot hits the front of the rim first), the sound can be generated for presentation as coming from behind the player. Similarly, sound can be generated to be presented corresponding to shots that are more left or right of the perfect shot.
      If a user is not bending their legs enough when taking a shot, IMRA technology can generate sound to be presented as coming from the area of a user's legs.
      If a user's elbow was not in an ideal position when shooting, IMRA technology can generate sound to be presented as coming from the area of a user's elbow while the elbow position went out of alignment.
   Soccer
      IMRA audio can be associated with the ball flight of a soccer ball so audio can be generated based on the ball movement to correspond to how much bend occurred on the ball when it was kicked.
      IMRA technology can analyze ball spin and can produce corresponding audio feedback.
      For free kicks, IMRA technology can produce sounds for presentation corresponding to the position in which the ball goes through the goal. For example, if a user is trying to hit the top right corner of the goal, if the ball goes through the desired location, IMRA technology can produce a sound for presentation seemingly from that area of the goal (spatially rendered sound).
   Football
      IMRA technology can provide a quarterback spatial audio cues to throw to a particular receiver and spatialized audio feedback based on the outcome of the throw.
      IMRA technology can provide an offensive lineman audio cues when and where they moved before the snap of the ball (e.g., shoulder flinched before snap). IMRA technology can provide an offensive lineman a spatially rendered audio of the quarterback and his position while going through the snap count.
   Volleyball
      Sound can be tied to the velocity of a volleyball so that if a volleyball is hit really hard, e.g., spiked or served, the sound can travel with the ball and can be more intense compared to the sound of a volleyball that is hit less hard or set.
First Responder Sound can be tied to the heart rate of a first responder to provide feedback on their physiological state and/or the sound of their prop gun after they shoot it. FIG. 15 illustrates examples of locations of spatial audio feedback provided by an IMRA system as described herein during golf, basketball, and soccer, respectively. The golf image, 1502 shows a swing error occurring on a player's backswing and an IMRA system detecting and providing an audio signal presented as from that location. The basketball image, 1504, shows the user's elbow is not in an ideal location when shooting the ball. Thus, the IMRA system provides a spatially specific sound presented as coming from the user's elbow while actively shooting the basketball. The soccer image, 1506, shows that an IMRA system can produce audio that can be presented as corresponding to the movement of the ball as it goes through the air. This can provide the user spatial audio feedback of the ball's movement.

As illustrated in the various examples described above, IMRA technology as described herein can be implemented in a variety of system configurations ranging from cloud-based to local and/or mobile based configurations. One component an IMRA system includes is an IMRA audio engine, which can be developed for various types of configurations, examples as discussed further herein. In some examples, an IMRA audio engine can be implemented natively using programming languages such as C++, Java, etc. In some examples, the IMRA audio engine can include off the shelf products such as Unity or Unreal. In some examples, an IMRA audio engine can handle a wide variety of tasks and processing including producing and causing presentation of a user interface, event trigger(s), experience and/or game logic, sourced and/or stored audio files, spatial rendering, an audio plugin, etc. In some examples, the IMRA audio engine can be integrated with audio middleware such as Wwise and/or FMOD and/or spatial audio plug-ins such as Google Resonance and/or Magic Leap Soundfield. In the illustrated examples below, components for the audio environment are shown as part of in the IMRA audio engine unless otherwise noted, though the IMRA technology is not so limited, and one or more of these components can be separate in some examples.

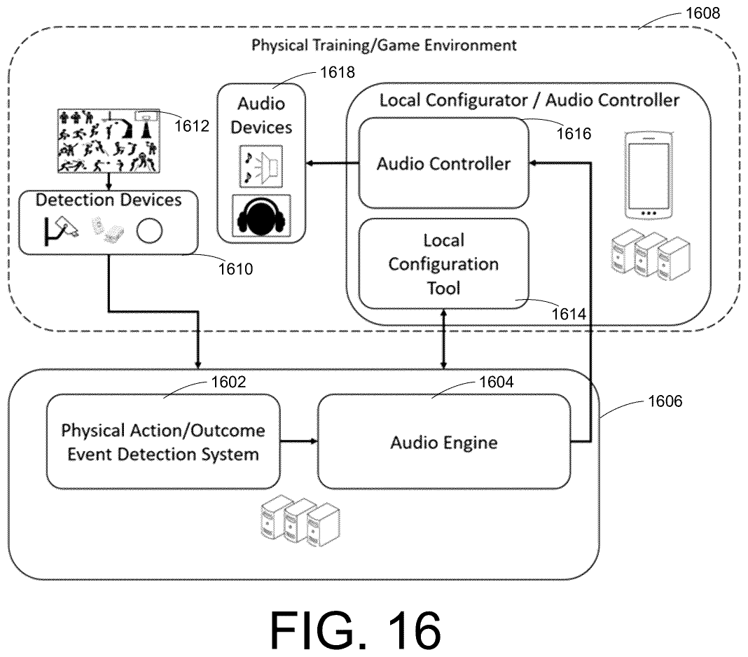

Initial example configurations of an IMRA system are presented in FIG. 1 and FIG. 2. FIGS. 16-26 present additional example configurations which can include configurations as presented in FIG. 1 and/or FIG. 2, and/or each other unless otherwise noted.

In the example illustrated in FIG. 16, an event detector 1602 and IMRA audio engine 1604 are associated with an integrated IMRA system 1606 for computing resources external to a user's physical environment 1608. Various components can be connected via TCP/IP or other connection protocol. A user can utilize their local configuration tool 1614 and audio controller 1616 (which in some examples may be combined) to configure the IMRA system for their desired audio experience scenario. After the event detector 1602 and IMRA audio engine components 1608 are started, the IMRA system 1606 can utilize various local detection devices 1610 (e.g., IP camera, IP sensors, ball with IP sensors, etc.) to capture various actions and outcomes 1612. This data can be transferred to local components and/or to the cloud where IMRA technology can apply various methodologies, e.g., computer vision, sensor tracking, machine learning, pattern matching, to determine if an event occurred. When IMRA technology determines that an event occurs, the IMRA system can determine, based on the IMRA audio engine configuration, which audio experience to produce, and can send the produced audio data to an audio controller 1616, which can then provide the audio to be played or presented via a local audio device(s) 1618.

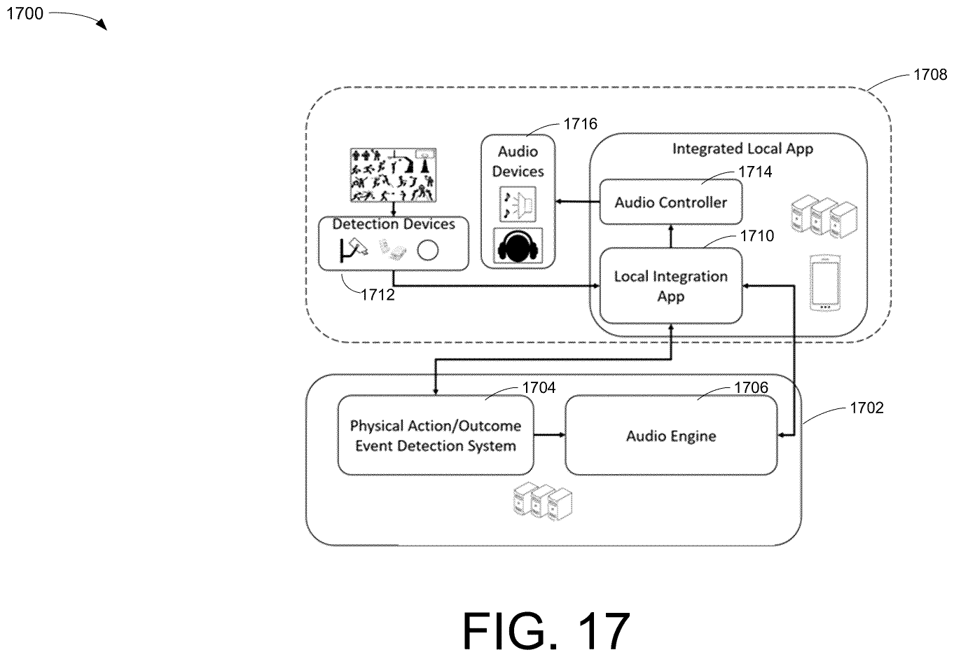

In examples, an integrated action detection and audio engine 1702, which can optionally include a physical action/outcome event detection system 1704 and an IMRA audio engine 1706, can optionally be remote from a physical training/game environment 1708. In the illustrated example, a local application associated with an IMRA system can include an integration app/tool 1710 that can interface with an event detection system 1712 and an IMRA audio engine 1714. In the example shown in FIG. 17, an IMRA associated local application running on a local device (e.g., a desktop, laptop, mobile device, customized device, etc.) can configure associated system(s) and/or components (e.g., detection devices, event detection system, and/or IMRA audio engine, etc.) to initialize based on received selection(s). An IMRA associated local integration app can capture action and/or outcomes from associated detection device(s) 1712 and transmit corresponding data to an associated event detection system 1704. The event detection system 1704 can relay an indication of event detection to an associated IMRA audio engine 1706, which can send an associated audio experience to an associated local integration app 1710. The local integration app 1710 can send audio to an associated audio controller 1714, which can play/present that audio via associated audio devices 1716.

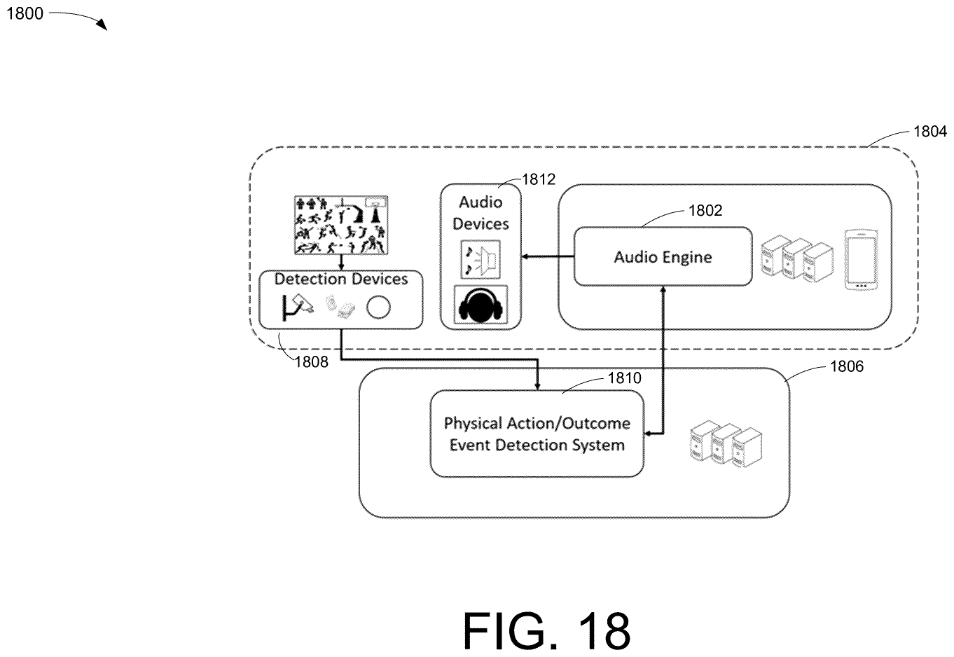

In the example shown in FIG. 18 associated with an IMRA system, an IMRA audio engine 1802 associated with a remote IMRA system 1804 can be local, within the physical/training/game environment 1806. In the example 1800, a local IMRA audio engine can be configured to connect with an IMRA associated event detection system 1808 via TCP/IP, for example, and the IMRA audio engine 1802 and/or the event detection system 1810 can communicate directly with associated audio device(s) 1812.

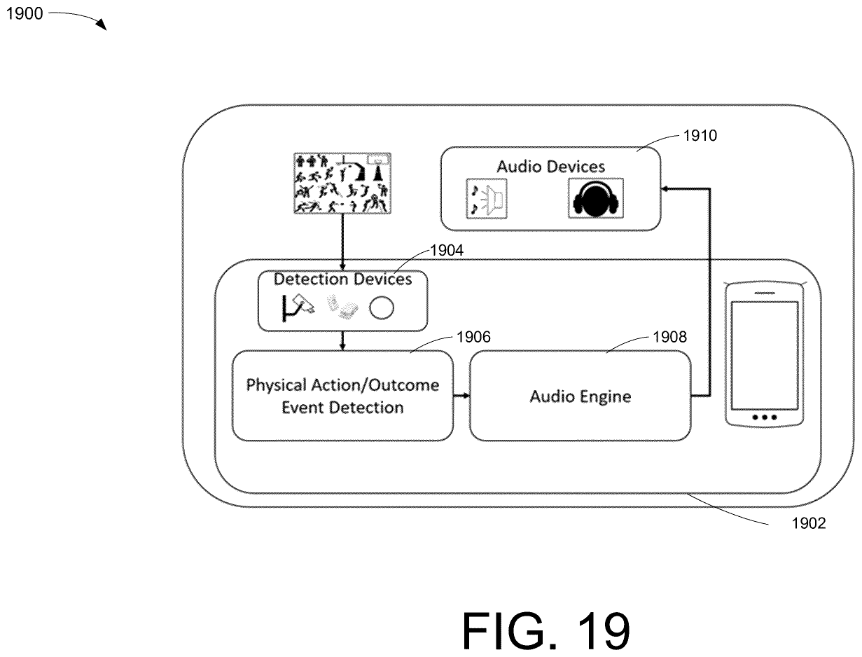

In some examples, such as that shown in FIG. 19, an IMRA system can exist in a physical training/game environment 1900 and can be configured to be implemented on a local device 1902 (e.g., desktop, laptop, mobile device, customized, etc.) such that IMRA functionality can be achieved through the local device. The local device can include detection devices 1904, which can provide input to a physical action/outcome detector 1906. The physical action/outcome detector 1906 can relay an indication of event detection to an associated IMRA audio engine 1908, which can send an associated audio experience to an associated audio device 1910

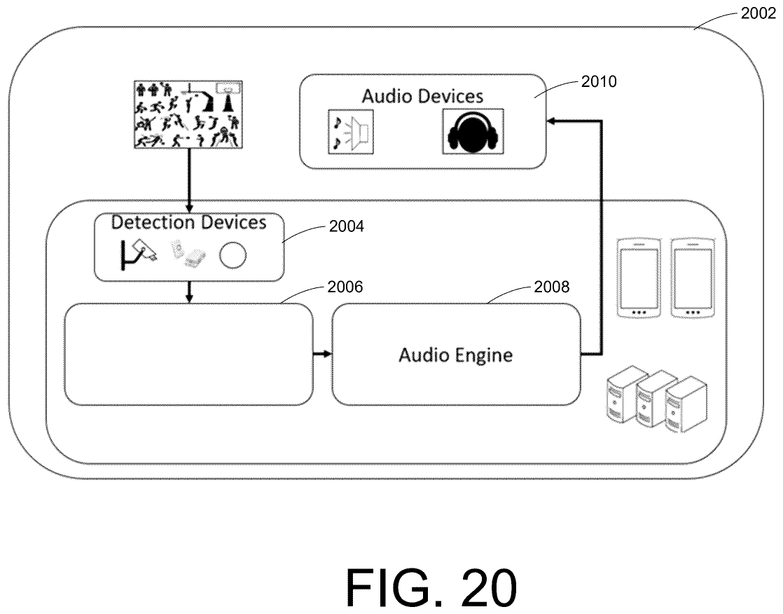

In examples, such as shown in FIG. 20, IMRA technology 2002 can be configured to integrate with existing system(s) that do not include an immersive audio component. Event detection devices 2004 can detect events, which can be provided to an existing system 2006. In some examples, the existing system 2006 may include the ability to detect actions in the physical environment and produce the associated game play, but largely depend on visuals to provide feedback and updates regarding the changes in the game environment. An IMRA audio engine 2008 system can be configured to integrate in with the other system 2006 to produce an immersive audio experience that mimics the visuals from the other systems 2006 and/or incorporates audio elements for presentation via audio device(s) 2010 that are beyond what is displayed on the screen. In some instances, a basketball app that utilizes computer vision to detect shots made and audibly count how many are made in a minute, can be configured with the IMRA technology to also generate playing in front of a large crowd that includes specific brands (e.g., Miami Heat). In some instances, a technology that simulates playing at a golf course can be integrated with the IMRA to provide the actual sounds from the particular golf course (e.g., ocean, birds, crowd, other players) to create an immersive and rich experience. For these instances, the IMRA system can be installed on the same hardware as the existing game system (e.g., personal computer, local tablet) or on separate hardware (e.g., tablet, mobile phone, cloud computers, etc.).

In some examples in which IMRA technology is integrated with an existing system, IMRA technology can be built into and/or incorporated into an existing system using the shared language or tools, as shown in FIG. 20. In these instances, the IMRA technology can utilize the same hardware and software as the existing system.

The examples shown in FIGS. 16-23 use an image of basketball actions solely for illustration. Event detection methods are available for other sports including golf (e.g., Putt Vision) and tennis (e.g., Hawkeye), and in other contexts. IMRA technology is applicable for actions associated with sports and/or other physical activities and can use commercially available and/or bespoke event detection methods.

This section describes examples of spatial audio components associated with IMRA technology and configurations along with other components of a spatial audio application for an example context.

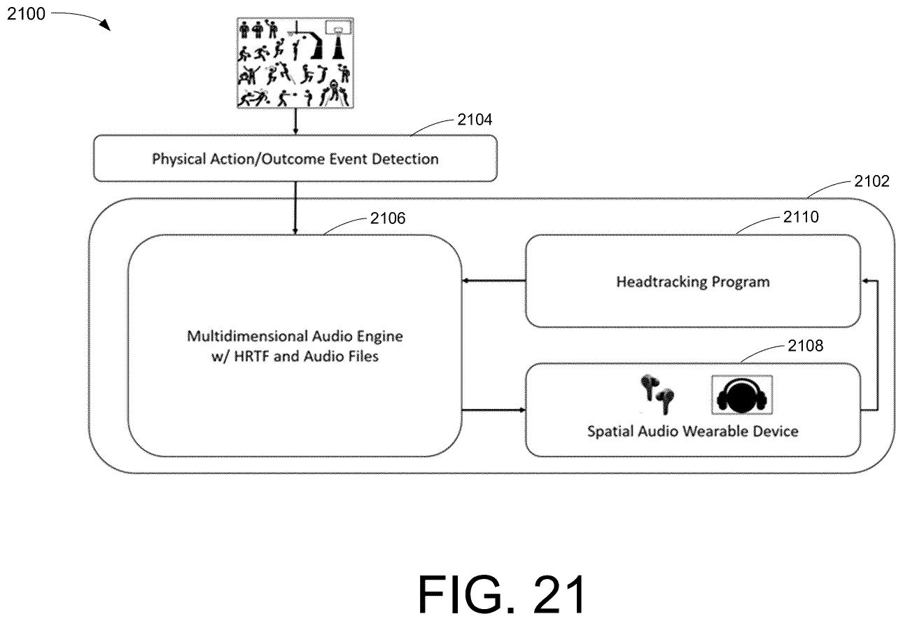

FIG. 21 illustrates a simplified configuration 2100 for spatial audio. FIG. 21 includes some of the same or similar modules and/or components from previous figures, though not all are shown. The figure is presented in the basketball context but can be applied to any other sport or physical training context. In 2100, illustrated components and/or modules include:
Physical Action/Outcome Event Detection Component 2104 (device(s) and/or logical module(s)), which can detect various actions/outcomes using various methods including computer vision and/or sensors. Though illustrated separate, Physical Action/Outcome Event Detection Component 2104 can be a part of and/or associated with an IMRA system 2102.
Multidimensional IMRA audio engine 2106, which can receive input based on detected events and generate a spatial audio experience for presentation.
Spatial Audio Wearable Device 2108, which can be in the form of earbuds with spatial capabilities, for example, which can receive the audio signal and can present audio.
Headtracking Program 2110, which can track the head positioning of the user so that the IMRA audio engine can produce an updated spatial audio experience that can correspond to the context of the action/outcome, physical training, game, and/or physical environment.

The event detection component can detect actions/outcomes, which can be converted to events that the event detection component can pass to an IMRA audio engine, in the illustrated example, the multidimensional IMRA audio engine, and associated with a designed audio experience. The headtracking program can determine the head position of the user and provide this information to the IMRA audio engine. The IMRA audio engine can produce a designed audio experience including a spatial audio experience based on the head positioning of the user and can produce an audio experience spatially using concepts such as HRTF for presentation via associated wearable device(s) with spatial audio capabilities.

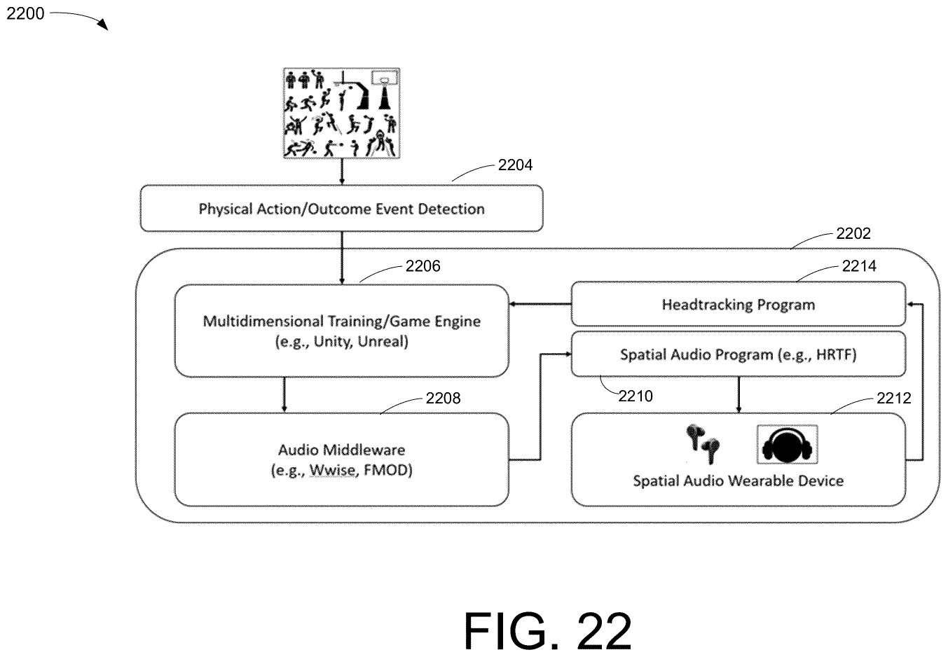

FIG. 22 illustrates example 2200, which includes some of the same or similar modules and/or components from the example of FIG. 21 and/or previous figures, though not all are shown. Physical Action/Outcome Event Detection Component 2204 (device(s) and/or logical module(s)), can detect various actions/outcomes using various methods including computer vision and/or sensors. Though illustrated separate, Physical Action/Outcome Event Detection Component 2204 can be a part of and/or associated with a system 2202. The IMRA technology in system 2202 in the illustrated example can include a commercially available or bespoke multidimensional training/game engine 2206 and/or a commercially available or bespoke audio middleware 2208 to separate out audio files and/or design. Multidimensional training/game engine 2206 can receive input from a headtracking program 2214, which can be a part of a separate device associated with an IMRA system (separate device not shown) or integrated in system 2202, which can include a spatial audio wearable device 2212. The input to headtracking program 2214 can be based on movement detected from wearable device(s) 2212. Based on detected events an IMRA audio engine receives, an event detection component can provide a detected event, the IMRA audio engine can produce an associated audio event, based on which the audio middleware is designed to produce. Examples of suitable commercial audio middleware include Wwise and FMOD. Further, in this configuration, the conversion of the audio feedback to a spatial format can be performed separately using a plugin 2210 that can perform the HRTF (or similar) conversion. Examples of suitable commercially available spatial audio plugins include Google Resonance and Magic Leap Soundfield). Wearable device(s) 2212 can receive and produce spatial audio. In examples in which the headtracking program 2214 is part of a separate device, headtracking can be performed by another wearable device that can detect head movement and/or other devices and/or sensors employing methods like computer vision.

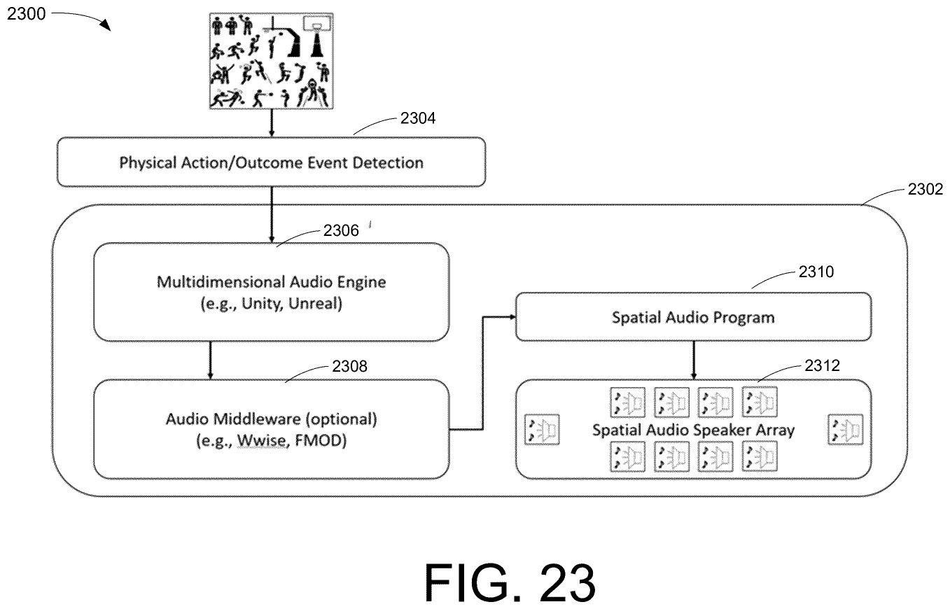

FIG. 23 illustrates example 2300, which includes some of the same or similar modules and/or components from the earlier examples, though not all are shown. The example IMRA system 2302, can be used in combination with any of the configurations illustrated in the previous figures and can generate spatial audio to present feedback using an array of speakers.

Physical Action/Outcome Event Detection Component 2304 (device(s) and/or logical module(s)), can detect various actions/outcomes using various methods including computer vision and/or sensors. Though illustrated separate, Physical Action/Outcome Event Detection Component 2304 can be a part of and/or associated with a system 2302. The IMRA technology in system 2302 in the illustrated example can include a multidimensional training/game engine 2206 and/or an audio middleware 2208 to separate out audio files and/or design. As shown in the illustration, head tracking can be omitted in some examples, or multidimensional training/game engine 2206 can receive input from a headtracking program, which can be a part of a separate device associated with an IMRA system (separate device not shown) or integrated in system 2302, which can include a spatial audio wearable device. The example IMRA system 2302, can include a spatial audio program 2310, which can generate spatial audio to present feedback using an array of speakers 2312.

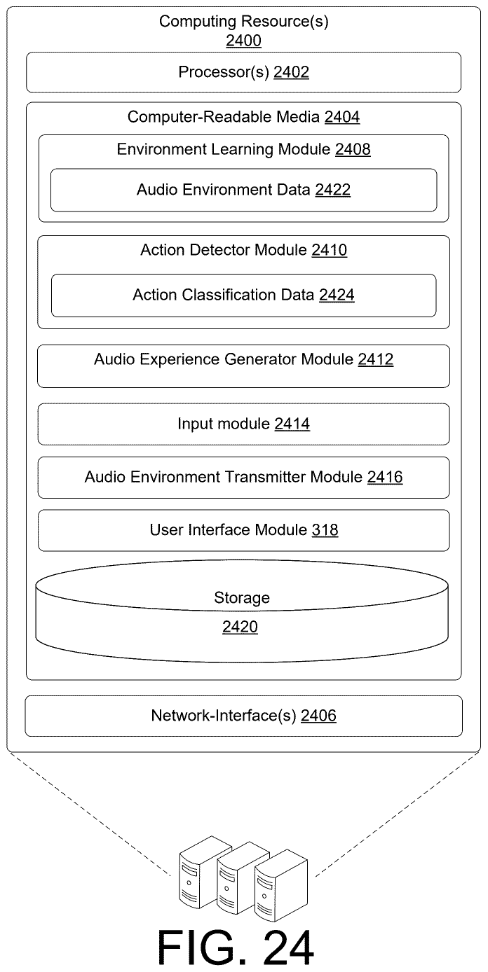

FIG. 24 is a block diagram illustrating an example computing resource 2400 of or that can be associated with an IMRA system. Computing resource 2400 can correspond to one or more of user electronic device 702 or computing resources 706, FIG. 7, or computing resources 908, FIG. 9. Computing resources 2400 represent one or more computing devices configured or programmed to implement IMRA technology and/or as part of an IMRA system as described herein. As shown, the computing resource 2400 can include processor(s) 2402, computer-readable media 2404, and one or more network-interface(s) 2406. In some examples, the processor(s) 2402 can process data and power the various hardware, software, and firmware components of the computing resource(s). As used herein, a processor, can include multiple processors and/or a processor having multiple cores. Further, the processors can include one or more cores of different types. In examples, the processors 2402 can include application processor units, graphic processing units, and so forth. In at least one example, the processor can include a microcontroller and/or a microprocessor. The processor(s) 2402 can include a graphics processing unit (GPU), a microprocessor, a digital signal processor or other processing units or components known in the art. Alternatively, or in addition, the functionality described herein can be performed, at least in part, by one or more hardware logic components. For example, and without limitation, illustrative types of hardware logic components that can be used include field-programmable gate arrays (FPGAs), application-specific integrated circuits (ASICs), application-specific standard products (ASSPs), system-on-a-chip systems (SOCs), complex programmable logic devices (CPLDs), etc. Processor(s) 2402 can include local memory, which also can store program components, program data, and/or one or more operating systems.

In various examples, computer-readable media 2404 can store various programming modules associated with an IMRA system as described herein, such as an environment learning module 2408, action detector module 2410, audio experience generator module 2412, audio environment transmitter or output module 2414, an input module 2416, a sound-storage module (not shown), a spatial audio module (not shown), a three-dimensional audio module (not shown), etc. and a user interface 2418, and/or a module including a combination of such. Computer-readable media 2404 can include storage 2404, which can include storage for data associated with one or more of the modules. In some examples, modules can have associated dedicated storage such as audio environment data 2422, action classification data 2424, etc.

As described herein, computer-readable media 2404 can include volatile and nonvolatile memory, removable and non-removable media implemented in any method or technology for storage of information, such as computer-readable instructions, data structures, program component, or other data. Such computer-readable media 2404 includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, RAID storage systems, or any other medium which can be used to store the desired information and which can be accessed by a computing device. The computer-readable media can be implemented as computer-readable storage media (“CRSM”), which can be any available physical media accessible by the processor(s) 2402 to execute instructions stored on the computer-readable media 2404. In one implementation, CRSM can include random access memory (“RAM”) and Flash memory. In other implementations, CRSM can include, but is not limited to, read-only memory (“ROM”), electrically erasable programmable read-only memory (“EEPROM”), or any other tangible medium which can be used to store the desired information, and which can be accessed by the processor(s).

Further, functional components can be stored in the respective memories, or the same functionality can alternatively be implemented in hardware, firmware, application specific integrated circuits, field programmable gate arrays, or as a system on a chip (SoC). In addition, while not illustrated, each respective memory, such as computer-readable media 2404, discussed herein can include at least one operating system (OS) component that is configured to manage hardware resource devices such as the network interface(s), the I/O devices of the respective apparatuses, and so forth, and provide various services to applications or components executing on the processors. Such OS component can implement a variant of the FreeBSD operating system as promulgated by the FreeBSD Project; other UNIX or UNIX-like variants; a variation of the Linux operating system as promulgated by Linus Torvalds; the FireOS operating system from Amazon. com Inc. of Seattle, Washington, USA; the Windows operating system from Microsoft Corporation of Redmond, Washington, USA; LynxOS as promulgated by Lynx Software Technologies, Inc. of San Jose, California; Operating System Embedded (Enea OSE) as promulgated by ENEA AB of Sweden; and so forth.

In some examples, the computing resource(s) 2400 can utilize one or more network interface(s) 2406 to communicate over wired and/or wireless networks. For instance, the network interface(s) 2406 can include wired or wireless interfaces, such as a wireless or Wi-Fi network communications interface, an Ethernet communications interface, a cellular network communications interface, a Bluetooth communications interface, etc., for communications with detection devices, input sensor(s), speaker(s), and/or user electronic device(s), e.g., 702 over various types of networks e.g., 704, 910, etc., including wide-area network, local-area networks, private networks, public networks etc. In the case of a wireless communications interfaces, such interfaces can include radio transceivers and associated control circuits and logic for implementing appropriate communication protocols. The network interface(s) 2406 can include logic for communicating using any different type of network communication protocol.

The environment learning module 2408 can store and/or receive audio environment data 2422. The environment learning module 2408 can use the audio environment data 320 to determine audio experiences associated with various audio environments. Additionally, or alternatively, the environment learning module 2408 can use audio environment data 2422 to determine associations between actions of an event and changes in an audio environment of a venue in which the event is held. In some examples, the environment learning module 2408 can perform machine learning and/or image processing techniques on the audio environment data 2422 to determine the above described associations. For instance, the environment learning module 2408 can be trained, such as by a neural network, a deep neural network, etc. to determine audio experiences associated with scoring a basket in basketball by pushing audio and/or video files to the environment learning module 2408 of users scoring baskets in an arena during a live game.

The action detector module 2410 of the computing resource(s) 2400 can store action classification data 2424. The action classification data 2424 can include associations between actions of users and athletic activities. The action classification data 2424 can include machine learning inputs and/or outputs such as from support vector machines, machine vision, data mining, etc. to classify actions of users such as made and missed basketball shots, and other actions described herein.

The audio experience generator module 2412 can access data associated with one or more inputs from an input module 2414. Inputs can correspond to actions of users.

The audio environment transmitter module 2416 can send audio conditioning data over the network(s) to the speakers for outputting audio created, generated, and/or modified via IMRA technology into the audio environment as described herein. The audio environment transmitter module 2416 can utilize the network-interface(s) 2406 of the computing resource(s) 2400 to send the audio for presentation.

The user interface module 2418 can be designed to present visual reports to the users and receive user system selections. System selections are related to which desired environment the user would like to condition in, which actions the user desires to have trigger changes in the audio environment, and which situational aspects the user desires the audio experience to recreate. For instance, the user can select to have the IMRA system output audio corresponding to a basketball game in a particular arena, to have specific audio output corresponding to when the user makes a basket, to have specific audio output corresponding to a specific person, a fictitious character, a famous character, etc., and/or to have specific audio output corresponding to a conference and/or playoff game. The user interface module 2418 can present visual reports to the user and/or receive the user system selections via one or more interface devices, such as a smartphone, LCD screen, tablet, laptop computer, desktop computer, smart television, etc.

### Example Additional and Optional Features of an IMRA System as Described Herein

An IMRA system can be configured to provide audio commercials while between actions/modes
An IMRA system can be configured to provide game results and/or analytics while between actions/modes. This can be specific to the user's location (e.g., when basketball player is at the top of the key, they get specific statistics of their performance from the top of the key) and/or can be spatially rendered to come from a particular area of the physical space.
An IMRA system can be configured to be integrated with content/songs on a device so that those content/songs are played but interrupted with feedback on actions and/or outcomes in the environment.
An IMRA system can be configured to incorporate AI and machine learning applied to actions/outcomes, e.g., to generate customized feedback and/or user challenges, and/or to automatically adjust the game and/or audio environment to optimize the training environment.
An IMRA system can be configured to receive some manual inputs actions/outcomes, which can be useful for:
   Scenarios where an operator/coach is present to train a user.
   Scenarios where a user wants to passively experience the audio environment to condition their reactions and/or visualize their performance environment.
   A user would like to experience the audio of an event or specific situation at an event remotely, e.g., to provide users of an application the ability to click on buttons on a screen to experience the audio environment of a game or another experience from specific locations in a particular arena or venue.
      This can be useful for colleges that can employ audio from specific locations in the college's arena, e.g., the student section, which can lead to increased applicants for college admissions from potential students wanting to attend the school. And/or, this can lead to increased ticket sales for games at the college.
      This can be useful for other venues to allow users to click on an area or seat to hear what it would sound like if they were at the desired production sitting in that section/seat of the arena or venue, which can boost premium (e.g., courtside, front row, etc.) seat purchases. In some examples, users may purchase virtual shared experiences incorporating IMRA technology to experience the production and/or live events from different locations of a physical or virtual venue.

### Example Clauses

1. An interactive-mixed-reality-audio (IMRA) system comprising:
a processor;
a computer-readable medium having thereon computer executable instructions to configure the system to perform operations comprising:
storing a plurality of sounds;
receiving sensor input;
detecting occurrence of an event based on the input received; generating audio signals to create an audio environment based on a sound of the plurality of sounds and the detected occurrence of the event; and
producing an audio output from the generated audio signals, the audio output representing the created audio environment.
2. An IMRA system as any of clauses 1, and/or 3-22 recites, wherein the computer-executable instructions include a spatial audio module to configure production of audio objects based on a sound of the plurality of sounds for the audio output to a audio environment associated with the detected occurrence of the event.
3. An IMRA system as any of clauses 1, 2, and/or 4-22 recites, wherein the plurality of sounds include at least one of:
a sound associated with an audio brands;
a sound associated with a specific person;
an existing recognizable sound;
a gamified sound;
an unrecognizable sound;
a sound from a microphone associated with the IMRA system;
a sound associated with a non-player character; or
an algorithmically created or modified sound.
4. An IMRA system as any of clauses 1-3, and/or 5-22 recites, wherein the sensor input received includes input based on at least one of: computer-vision input, infrared sensor input, image-sensor input, audio-sensor input, wearable sensor input, embedded sensor input.
5. An IMRA system as any of clauses 1-4, and/or 6-22 recites, wherein received input includes manual entry from an operator.
6. An IMRA system as any of clauses 1-5, and/or 7-22 recites, wherein the manual input received is associated with selection of a preset audio environment.
7. An IMRA system as any of clauses 1-6, and/or 8-22 recites, wherein the sensor input received includes at least one of audio input or image input.
8. An IMRA system as any of clauses 1-7, and/or 9-22 recites, wherein the event includes at least one of:
a series of motions;
a location;
a pose;
a posture-change flow;
an outcome from an action;
a physiological state;
motion of a non-human object; or
situational factors; or
judgement of a human observer; and
the computer-readable medium has thereon computer executable instructions to configure the system to perform operations further comprising ascertaining a user action based on detection of the occurrence of the event and/or to identify an outcome based on detection of the occurrence of the event.
9. An IMRA system as any of clauses 1-8, and/or 10-22 recites, wherein the computer executable instructions include a machine learning module configured to apply a learned and/or trained machine learning model to at least one of associations between events and the created audio environment.
10. An IMRA system as any of clauses 1-9, and/or 11-22 recites, wherein the computer executable instructions include instructions to generate three-dimensional or greater dimensional audio signals.
11. An IMRA system as any of clauses 1-10, and/or 12-22 recites, wherein the computer executable instructions include instructions to produce audio output based on the generated audio signals, the produced audio output configured for mono, stereo, and/or spatial presentation by one or more of: an installed/venue loudspeaker, a portable loudspeaker, headphones, earbuds, a multi-speaker array, and/or a spatial audio wearable.
12. An IMRA system as any of clauses 1-11, and/or 13-22 recites, wherein one or more preset and/or customized audio environments comprise one or more of the plurality of sounds stored.
13. An IMRA system as any of clauses 1-12, and/or 14-22 recites, wherein a preset and/or customized audio environment includes a realistic, fictional, and/combined realistic and fictional audio environment generated from some of the plurality of the sounds stored.
14. An IMRA system as any of clauses 1-13, and/or 15-22 recites, wherein the created audio environment includes an interactive audio environment.
15. An IMRA system as any of clauses 1-14, and/or 16-22 recites, wherein the computer-executable instructions include a spatial audio module to produce an association between a virtual audio object, with or without a corresponding physical object in a physical environment, and a corresponding presence in the created audio environment.
16. An IMRA system as any of clauses 1-15, and/or 17-22 recites, wherein the computer-executable instructions include a spatial audio module to generate a virtual audio object in the created audio environment for presentation in the physical environment.
17. An IMRA system as any of clauses 1-16, and/or 18-22 recites, wherein the generating signals includes generating signals to produce audio output, the produced audio output configured for mono, stereo, and/or spatial presentation by one or more of: an installed/venue loudspeaker, a portable loudspeaker, headphones, earbuds, a multi-speaker array, and/or a spatial audio wearable.
18. An IMRA system as any of clauses 1-17, and/or 19-22 recites, wherein:
at least one of:
the receiving sensor input includes input from two or more locations; or
the detecting occurrence of the event is based on the input from the two or more locations;
the generating the audio signals to create the created audio environment is based on the sound of the plurality of sounds and at least one of:
the sensor input from the two or more locations; or
the occurrence of the event based on the input from the two or more locations; and
the audio output from the generated audio signals represents a shared audio environment produced for presentation at the two or more locations.
19. An IMRA system as any of clauses 1-18 recites, wherein:
one or more preset and/or customized audio environments comprise one or more of the plurality of sounds stored, and the one or more preset and/or customized audio environments is selectable from a first location as a selected audio environment; and
a second location can join the selected audio environment to make the selected audio environment a shared audio environment.
20. An IMRA system as clause 19 recites, wherein selection from the second location can customize the shared audio environment as make a customized audio environment in the second location.
21. An IMRA system as clause 20 recites, wherein sharing can be selected from the second location to share the customized audio environment in the second location with the first location offering a replacement shared audio environment.
22. An IMRA system as clause 21 recites, wherein the first location can join the replacement shared audio environment.
23. An interactive-mixed-reality-audio (IMRA) system comprising:
a sensor-input receiver,
an event detector;
an IMRA audio engine;
optionally, a spatial-audio component;
an audio output generation device to generate a created audio environment.
24. An IMRA system as any of clauses 23, and/or 25-43 recites, wherein the sensor-input receiver is configured as a receiver for a signal associated with at least one of: a computer-vision sensor, an infrared sensor, an image sensor, a wearable sensor, an embedded sensor, an audio sensor, a microphone, or a touch sensor.
25. An IMRA system as any of clauses 23, 24, and/or 26-43 recites, further comprising a storage device storing a plurality of sounds include at least one of:
a sound associated with an audio brand;
a sound associated with a specific person;
an existing recognizable sound;
a gamified sound;
an unrecognizable sound;
a sound from a microphone associated with the IMRA system;
a sound associated with a non-player character; or
an algorithmically generated and/or modified sound.
26. An IMRA system as any of clauses 23-25, and/or 27-43 recites, wherein input received includes input based on at least one of: computer-vision input, image-sensor input, infrared input, audio-sensor input, wearable-sensor input, input from an embedded sensor, input from an audio sensor or microphone, a touch input, or a manual entry from an operator.
27. An IMRA system as any of clauses 23-26, and/or 28-43 recites, wherein the event detector is configured to recognize one or more of:
a series of motions;
a location;
a pose;
posture-change flow;
an outcome from an action;
a physiological state;
motion of a non-human object;
situational factors; or
judgement of a human observer; and
to ascertain a user action based on the recognition and/or to identify an outcome based on the recognition.
28. An IMRA system as any of clauses 23-27, and/or 29-43 recites, wherein the event detector includes a machine learning module configured to apply a learned machine learning model to at least one of associations between events and the created audio environment.
29. An IMRA system as any of clauses 23-28, and/or 30-43 recites, wherein the input, which can include manual input, is associated with selection of a specific location, positioning and/or object in a preset audio environment.
30. An IMRA system as any of clauses 23-29, and/or 31-43 recites, wherein the sensor input received includes at least one of audio input or image input.
31. An IMRA system as any of clauses 23-30, and/or 32-43 recites, wherein the IMRA audio engine includes a three-dimensional or greater dimensional IMRA audio engine.
32. An IMRA system as any of clauses 23-31, and/or 33-43 recites, wherein the audio output generation device is configured to generate signals to produce audio output, the produced audio output configured for mono, stereo, and/or spatial presentation by one or more of: an installed/venue loudspeaker, a portable loudspeaker, headphones, earbuds, a multi-speaker array, and/or a spatial audio wearable.
33. An IMRA system as any of clauses 23-32, and/or 34-43 recites, wherein the IMRA audio engine is configured to produce an association between a virtual audio object with or without a corresponding physical object in a physical environment, and a corresponding presence in the created audio environment.
34. An IMRA system as any of clauses 23-33, and/or 35-43 recites, wherein the audio output generation device is configured to, based on a sound of the plurality of sounds, generate a virtual audio object in the created audio environment for presentation in the physical environment.
35. An IMRA system as any of clauses 23-34, and/or 36-43 recites, wherein one or more preset and/or customized audio environments comprise one or more of the plurality of sounds stored.
36. An IMRA system as any of clauses 23-35, and/or 37-43 recites, wherein a preset and/or customized audio environment includes a realistic, fictional, or combined realistic and fictional audio environment generated from some of the plurality of the sounds stored.
37. An IMRA system as any of clauses 23-36, and/or 38-43 recites further comprising an audio middleware component or module.
38. An IMRA system as any of clauses 23-37, and/or 39-43 recites further comprising a training-device integrated component or module.
39. An IMRA system as any of clauses 23-38, and/or 40-43 recites, wherein a training-device integrated transceiver is configured to receive signals from one or more integrated components or modules.
40. An IMRA system as any of clauses 1-39 and/or 41-43 recites, wherein one or more associated components include a sensor embedded in, affixed to, and/or associated with one or more sports and/or professional tools or equipment, such as: a speaker, a ball, a hoop, a goal, a puck, a helmet, a bat, a club, a stick, a racket, a shoe, a gymnastics ribbon, a firehose, other machinery, tools, or equipment, or a wearable, and/or the IMRA system includes a sensor embedded in, affixed to, and/or associated with one or more of: a speaker, a ball, a hoop, a goal, a puck, a helmet, a bat, a stick, a racket, a shoe, a gymnastics ribbon, a firehose, other machinery, tools, or equipment, or a wearable.
41. An IMRA system as any of clauses 1-40, 42, and/or 43 recites, wherein at least one sensor component includes a computer-vision component.
42. An IMRA system as any of clauses 1-41, and/or 43 recites, wherein a speaker is associated with a sensor embedded in, affixed to, and/or associated with one or more of: a mannequin, a ball, a hoop, a goal, a puck, a bat, a club, a stick, a racket, a shoe, or a wearable.
43. An IMRA system as any of clauses 1-42 recites, wherein an audio object is associated with a sensor embedded in, affixed to, and/or associated with one or more of: a mannequin, a ball, a hoop, a goal, a puck, a bat, a club, a stick, a racket, a shoe, or a wearable.
44. A method associated with interactive-mixed-reality-audio (IMRA), the method comprising:
storing a plurality of sounds;
receiving sensor input;
detecting occurrence of an event based on the input received;
generating audio signals to create a created audio environment based on a sound of the plurality of sounds and the detected occurrence of the event; and
producing an audio output from the generated audio signals, the audio output representing the created audio environment.
45. A method as any of clauses 44 and/or 46-52 recites, further comprising configuring production of the audio output to a audio environment associated with the detected occurrence of the event.
46. A method as any of clauses 44, 45, and/or 47-52 recites, further comprising ascertaining a user action based on detection of the occurrence of the event.
47. A method as any of clauses 44-46, and/or 48-52 recites, further comprising ascertaining a user action based on detection of the occurrence of the event based on computer vision.
48. A method as any of clauses 44-47, and/or 49-52 recites, further comprising identifying an outcome based on detection of the occurrence of the event.
49. A method as any of clauses 44-48, and/or 50-52 recites, further comprising identifying an outcome based on detection of the occurrence of the event based on computer vision.
50. A method as any of clauses 44-49, 51, and/or 52 recites, further comprising determining location, gesture, pose, state, motion, and/or outcome associated with occurrence of the detected event.
51. A method as any of clauses 44-50, and/or 52 recites, further comprising generating three-dimensional or greater-dimensional audio signals.
52. A method as any of clauses 23-52 recites, further comprising producing audio output based on the generated audio signals, the produced audio output configured for mono, stereo, and/or spatial presentation by one or more of: an installed/venue loudspeaker, a portable loudspeaker, headphones, earbuds, a multi-speaker array, and/or a spatial audio wearable.
53. One or more methods associated with interactive-mixed-reality-audio (IMRA).
54. A computer-readable medium including computer-executable instructions for performing one or more methods associated with interactive-mixed-reality-audio (IMRA) as any one or more of clauses 1-53 recite.
55. A system comprising:
a processor; and
a computer-readable medium including computer-executable instructions for performing one or more methods associated with interactive-mixed-reality-audio (IMRA) as any one or more of clauses 1-53 recite.

1.-20. (canceled)

21. An interactive-mixed-reality-audio (IMRA) system comprising:
a sensor-input receiver;
an event detector;
an IMRA audio engine, wherein the IMRA audio engine includes a three-dimensional audio engine; and
an audio output generation device to generate a created audio environment comprising at least one of:
a preset created audio environment changeable based on real and fictional sources; or
a customized created audio environment changeable based on real and fictional sources,
wherein the created audio environment dynamically changes based on at least one of: a detected physical action of a user, or
an outcome of performance of physical training or a gaming activity of the user.

22. The IMRA system of claim 21, wherein the sensor-input receiver is configured as a receiver for a signal associated with at least one of: a computer-vision sensor, an infrared sensor, an image sensor, a wearable sensor, an embedded sensor, an audio sensor, a microphone, or a touch sensor.

23. The IMRA system of claim 21, further comprising a storage device storing a plurality of sounds that include a sound from a microphone associated with the IMRA system and at least one of:
a sound associated with an audio brand;
a sound associated with a specific person;
an existing recognizable sound;
a gamified sound;
an unrecognizable sound;
a sound associated with a non-player character; or
an algorithmically created or modified sound.

24. The IMRA system of claim 21, wherein input received comprises at least one of: computer-vision input, image-sensor input, infrared input, audio-sensor input, wearable-sensor input, input from an embedded sensor, input from an audio sensor or microphone, a touch input, or a manual entry from an operator.

25. The IMRA system of claim 21,
wherein the event detector is configured to recognize one or more of:
an event-signifying word or phrase;
a series of motions;
a location;
a pose;
posture-change flow;
an outcome from an action;
a physiological state;
motion of a non-human object;
situational factors; or
judgement of a human observer, and
wherein the event detector is configured to at least one of ascertain a user action based on the recognizing or identify an outcome based on the recognizing.

26. The IMRA system of claim 21, wherein the event detector includes a machine learning module configured to apply a learned or trained machine learning model to output associations between events and the created audio environment.

27. The IMRA system of claim 21, wherein the IMRA audio engine is configured to produce an association between a virtual audio object without reliance on existence of a corresponding physical object in a physical environment, and a corresponding presence in the created audio environment.

28. The IMRA system of claim 21, further comprising an audio middleware component or module configured to design and manage one or more audio objects within the created audio environment, wherein the one or more audio objects correspond to designed elements of a preconfigured or customized immersive audio experience.

29. The IMRA system of claim 21, further comprising a training-device integrated component or module configured to apply machine learning to an association between a detected event and the created audio environment.

30. The IMRA system of claim 21, wherein a training-device integrated transceiver is configured to receive signals from one or more integrated components or modules configured to apply a machine learning module to at least one association between a detected event and the created audio environment.

31. The IMRA system of claim 21, wherein a speaker is associated with a sensor embedded in, affixed to, and/or associated with one or more of: a mannequin, a ball, a hoop, a goal, a puck, a bat, a club, a stick, a racket, a shoe, a ribbon, a tool, equipment, or a wearable.

32. The IMRA system of claim 21, wherein an audio object is associated with a sensor embedded in, affixed to, and/or associated with one or more of: a mannequin, a ball, a hoop, a goal, a puck, a bat, a club, a stick, a racket, a shoe, a ribbon, a wearable, a tool, or equipment, to enable user activity associated with an event.

33. A method associated with interactive-mixed-reality-audio (IMRA), the method comprising:
storing a plurality of sounds including at least one gamified sound;
receiving sensor input associated with one or more physical actions of a user performing physical training or gaming activities;
detecting occurrence of an event based on the sensor input, wherein the event comprises at least one of a physical action of the one or more physical actions or an outcome of the physical action;
generating three-dimensional audio signals to create a created audio environment that dynamically changes based on the at least one of the physical action or the outcome of the physical action, and producing an audio output from the three-dimensional audio signals, the audio output representing the created audio environment.

34. The method of claim 33, wherein detecting the occurrence of the event comprises is based at least in part on computer vision.

35. The method of claim 33, further comprising determining a gesture of a limb of the user and one or more of: location, pose, state, motion, or the outcome associated with occurrence of the event, wherein the gesture of the limb of the user is determined to dynamically change the created audio environment based on the gesture during the physical training or the gaming activities.

36. The method of claim 33, wherein the audio output is configured for mono, stereo, and/or spatial presentation by one or more of: an installed/venue loudspeaker, a portable loudspeaker, headphones, earbuds, a multi-speaker array, or a spatial audio wearable.

37. The method of claim 33, wherein the sensor input comprises one or more of a heart rate or a blood oxygen level.

38. The method of claim 33, wherein the event comprises both the physical action and the outcome of the physical action, and wherein the created audio environment dynamically changes based on both the physical action and the outcome of the physical action.

39. The method of claim 33, wherein the audio output is output to at least two users, in a plurality of locations, synchronously.

40. The method of claim 33, wherein the sensor input is first sensor input, wherein the one or more physical actions are one or more first physical actions, wherein the physical action is a first physical action, wherein the physical training is first physical training, wherein the gaming activities are first gaming activities, wherein the user is a first user, wherein the event is a first event, wherein the outcome is a first outcome, the three-dimensional audio signals are first three-dimensional audio signals, the method further comprising:
receiving second sensor input associated with one or more second physical actions of a second user performing second physical training or second gaming activities;
detecting occurrence of a second event based on the second sensor input, wherein the second event comprises at least one of a second physical action of the one or more second physical actions or a second outcome of the second physical action; and
generating second three-dimensional audio signals, wherein the created audio environment is based on the first three-dimensional audio signals and the second three-dimensional audio signals and dynamically changes based on at least one of the first physical action, the first outcome, the second physical action, or the second outcome.
